(19) United States
(12) Patent Application Publication
(10) Pub. No.: US 2024/0393648 A1
(43) Pub. Date: Nov. 28, 2024

(54) ARRAY SUBSTRATE, TESTING METHOD THEREFOR, AND DISPLAY APPARATUS

(71) Applicants: Hefei BOE Optoelectronics Technology Co., Ltd., Hefei,Anhui (CN); BOE Technology Group Co., Ltd., Beijing (CN)

(72) Inventors: Dong WANG, Beijing (CN); Hongmin LI, Beijing (CN); Fengjing TANG, Beijing (CN)

(21) Appl. No.: 18/695,004

(22) PCT Filed: Aug. 9, 2023
(86) PCT No.: PCT/CN2023/111977

§ 371 Date: Mar. 25, 2024

(30) Foreign Application Priority Data
Aug. 31, 2022 (CN) 202211066508.2

(51) Int. Cl. G02F 1/1362; G02F 1/1368; G06F 3/044; G09G 3/00

(52) U.S. Cl. CPC G02F 1/136254; G02F 1/136263; G02F 1/136286; G02F 1/1368; G06F 3/0446; G09G 3/006; G09G 2330/12

(57) ABSTRACT

An array substrate, a testing method therefor and a display apparatus. The array substrate comprises multiple touch control electrodes forming multiple touch control rows and multiple touch control columns, and multiple pixel units forming multiple pixel rows and multiple pixel columns, the orthographic projection of the touch control electrodes on the array substrate at least partially overlapping the orthographic projection of the multiple pixel units on the array substrate, and the pixel units comprising multiple sub-pixels; a touch control lead group is arranged in the middle of at least one adjacent pixel column, the touch control lead group at least comprising a first lead and a second lead arranged in parallel, and the first lead is connected to one of the touch control electrodes in one touch control row, and the second lead is connected to another touch control electrode in the adjacent touch control row.

### CROSS-REFERENCE TO RELATED APPLICATION

The present application is a U.S. National Phase Entry of International Application No. PCT/CN2023/111977 having an international filing date of Aug. 9, 2023, which claims the priority to Chinese Patent Application No. 202211066508.2 filed to the CNIPA on Aug. 31, 2022 and entitled “Array Substrate, Testing method Therefor, and Display Apparatus”. The above-identified applications are incorporated into the present application by reference in their entireties.

### TECHNICAL FIELD

The present disclosure relates to, but is not limited to, the field of display technologies, and particularly to an array substrate and a testing method therefor, and a display apparatus.

### BACKGROUND

With rapid development of display technology, Touch Screen Panel has gradually spread throughout people's lives. According to composition structures, types of touch screen panels may be divided into Add on Mode type, On Cell type, In Cell type, and so on. In the touch screen panel of the add on mode type, a touch module and a display module are produced separately, and then laminated together into a touch screen panel with a touch function, which has the disadvantages such as high production cost, low light transmittance, thick modules. In the touch screen panel of the in cell type, touch electrodes of the touch module are embedded inside the display module, which not only greatly reduces the overall thickness of the module, but also greatly reduces the production cost, and gradually becomes the mainstream of capacitive touch screen panel.

### SUMMARY

The following is a summary of subject matter described herein in detail. The summary is not intended to limit the scope of protection of the claims.

In one aspect, the present disclosure provides an array substrate including a display region, the display region includes at least: a plurality of touch electrodes constituting a plurality of touch rows and a plurality of touch columns, and a plurality of pixel units constituting a plurality of pixel rows and a plurality of pixel columns, orthographic projections of the touch units on the array substrate are at least partially overlapped with orthographic projections of the plurality of pixel units on the array substrate, a pixel unit includes a plurality of sub-pixels; a touch lead group is provided between at least one adjacent pixel columns; the touch lead group includes at least a first lead and a second lead provided side by side; the first lead is connected with a touch electrode in a touch row, and the second lead is connected with another touch electrode in an adjacent touch row.

In an exemplary implementation mode, at least one touch column includes N touch electrodes arranged sequentially along a pixel column direction, an orthographic projection of the touch column on the array substrate is at least partially overlapped with orthographic projections of N/2 pixel columns on the array substrate, the first lead located between an i-th pixel column and an (i+1)-th pixel column is connected to touch electrodes in an (2i-1)-th touch row, the second lead located between the i-th pixel column and the (i+1)-th pixel column is connected to touch electrodes in an 2i-th touch row, Nis an even number greater than 1, and i is a positive integer greater than or equal to 1 and less than or equal to N/2.

In an exemplary implementation mode, at least one pixel unit includes a first sub-pixel, a second sub-pixel and a third sub-pixel arranged sequentially along a pixel row direction, the sub-pixel includes a gate line, a data line, a thin film transistor and a pixel electrode, the thin film transistor is respectively connected to the gate line, the data line and the pixel electrode, the touch electrode is reused as a common electrode, and the first lead and the second lead are reused as common electrode lines; the first lead is disposed at a side of the third sub-pixel away from the first sub-pixel, and the second lead is disposed at a side of the first lead away from the first sub-pixel.

In an exemplary implementation mode, in at least one pixel row, a first connection block is provided on the first lead, and the first connection block is connected with one touch electrode through a first via.

In an exemplary implementation mode, in at least one pixel row, the first lead includes at least a first straight line segment, a second straight line segment, and a bending segment between the first straight line segment and the second straight line segment, a first end of the bending segment is connected to the first straight line segment, a second end of the bending segment is connected to the second straight line segment, a middle part of the bending segment protrudes in a direction away from the second lead, and the first connection block is disposed in a region formed by bending of the bending segment.

In an exemplary implementation mode, an orthographic projection of the first connection block on the array substrate is overlapped at least partially with an orthographic projection of the gate line on the array substrate.

In an exemplary implementation mode, an orthographic projection of the first via on the array substrate is overlapped at least partially with an orthographic projection of the gate line on the array substrate.

In an exemplary implementation mode, in at least one pixel row, a second connection block is provided on the second lead, and the second connection block is connected with another touch electrode through a second via.

In an exemplary implementation mode, in at least one pixel row, the first lead includes at least a first straight line segment, a second straight line segment, and a bending segment between the first straight line segment and the second straight line segment, a first end of the bending segment is connected to the first straight line segment, a second end of the bending segment is connected to the second straight line segment, a middle part of the bending segment protrudes in a direction away from the second lead, and the second connection block is disposed in a region formed by bending of the bending segment.

In an exemplary implementation mode, an orthographic projection of the second connection block on the array substrate is overlapped at least partially with an orthographic projection of the gate line on the array substrate.

In an exemplary implementation mode, an orthographic projection of the second via on the array substrate is overlapped at least partially with an orthographic projection of the gate line on the array substrate.

In an exemplary implementation mode, in at least one pixel unit, the touch electrode includes an electrode part disposed within the pixel unit and a connection part disposed between adjacent pixel units and connected with electrode parts within the adjacent pixel units.

In an exemplary implementation mode, in at least one pixel unit, an orthographic projection of the electrode part on the array substrate is not overlapped with an orthographic projection of the gate line on the array substrate, an orthographic projection of the electrode part on the array substrate is not overlapped with an orthographic projection of the first lead line on the array substrate, and an orthographic projection of the electrode part on the array substrate is not overlapped with an orthographic projection of the second lead line on the array substrate.

In an exemplary implementation mode, in at least one pixel unit, an orthographic projection of the connection part on the array substrate is at least partially overlapped with an orthographic projection of the gate line on the array substrate, an orthographic projection of the connection part on the array substrate is at least partially overlapped with an orthographic projection of the first lead line on the array substrate, and an orthographic projection of the connection part on the array substrate is at least partially overlapped with an orthographic projection of the second lead line on the array substrate.

In an exemplary implementation mode, in at least one pixel unit, at least one connection part is connected to the first lead through a first via, or at least one connection part is connected to the second lead through a second via.

In an exemplary implementation mode, the array substrate further includes a bonding region located at a side of the display region and an upper bezel region located at a side of the display region away from the bonding region; the bonding region includes at least a plurality of pins, the upper bezel region includes at least a test circuit, the test circuit is correspondingly connected with the plurality of pins of the bonding region through a plurality of connection lines, and the test circuit is configured to detect short circuit defects of the array substrate.

In an exemplary implementation mode, the test circuit includes a plurality of test units corresponding to positions of the plurality of touch columns; at least one test unit includes a first test line, a second test line, a switch control line, a first switch and a second switch; the first test line is connected with the first lead in the display region through the first switch, the second test line is connected with the second lead in the display region through the second switch, and the switch control line is connected with control terminals of the first switch and the second switch; the first test line is configured to transmit a first gray-scale voltage to the first lead under control of the switch control line, and the second test line is configured to transmit a second gray-scale voltage to the second lead under control of the switch control line; a voltage value of the first gray-scale voltage is greater than a voltage value of the second gray-scale voltage, or the voltage value of the first gray-scale voltage is less than the voltage value of the second gray-scale voltage.

In an exemplary implementation mode, the test unit further includes a first data lead, a second data lead, a third data lead, a third switch, a fourth switch, and a fifth switch, the first data lead is connected with a data line of a first sub-pixel in the display region through the third switch, the second data lead is connected with a data line of a second sub-pixel in the display region through the fourth switch, the third data lead is connected with a data line of a third sub-pixel in the display region through the fifth switch, the switch control line is connected with control terminals of the third switch, the fourth switch and the fifth switch; the first data lead, the second data lead, and the third data lead are configured to transmit a common reference voltage to data lines of the display region under control of the switch control line.

In another aspect, the present disclosure also provides a display apparatus, including the aforementioned array substrate.

In yet another aspect, the present disclosure also provides a testing method for an array substrate using the above-mentioned array substrate, including:
providing turn-on voltages to a plurality of gate lines in a display region, to turn on thin film transistors of a plurality of sub-pixels in the display region; providing a common reference voltage to a plurality of data lines in the display region, to cause pixel electrodes of the plurality of sub-pixels in the display region to have the common reference voltage;
providing a first gray-scale voltage to a first lead in the display region to cause a plurality of touch electrodes connected to the first lead in the display region to have a first gray-scale voltage; providing a second gray-scale voltage to a second lead in the display region to cause a plurality of touch electrodes connected to the second lead in the display region to have a second gray-scale voltage; wherein a voltage value of the first gray-scale voltage is greater than a voltage value of the second gray-scale voltage, or the voltage value of the first gray-scale voltage is less than the voltage value of the second gray-scale voltage.

In an exemplary implementation mode, when there is no short circuit defect on the array substrate, touch electrodes in one touch row display a first gray scale, touch electrodes in an adjacent touch row display a second gray scale, and the display region presents a display picture that is alternately brightened and darkened in a longitudinal direction; when there is a short circuit defect on the array substrate, at least one touch electrode in one touch row displays a same gray scale as at least one touch electrode in an adjacent touch row.

Other aspects of the present disclosure may be comprehended after the drawings and the detailed descriptions are read and understood.

### BRIEF DESCRIPTION OF DRAWINGS

Accompany drawings are used to provide further understanding of technical solution of the present disclosure, and form a part of the description. The accompany drawings and embodiments of the present disclosure are adopted to explain the technical solution of the present disclosure, but do not form limitations on the technical solution of the present disclosure.

FIG. 1 is a schematic sectional view of a liquid crystal display.

FIG. 2 is a schematic diagram of a planar structure of a liquid crystal display.

FIG. 3 is a schematic diagram of a planar structure of an array substrate.

FIG. 4 is a schematic diagram of a structure of an In-Cell touch screen panel.

FIG. 5 is a schematic diagram of a planar structure of an array substrate according to an exemplary embodiment of the present disclosure.

FIG. 6 is a schematic diagram of a planar structure of a display region according to an exemplary embodiment of the present disclosure.

FIG. 7a is an enlarged view of a region A in FIG. 6.

FIG. 7b is an enlarged view of a region B in FIG. 6.

FIGS. 8a and 8b are schematic views of an array substrate after a pattern of a first conductive layer is formed according to the present disclosure.

FIGS. 9a and 9b are schematic views of an array substrate after a pattern of a semiconductor layer is formed according to the present disclosure.

FIGS. 10a and 10b are schematic views of an array substrate after a pattern of a second conductive layer is formed according to the present disclosure.

FIGS. 11a and 11b are schematic views of an array substrate after a pattern of a second insulating layer is formed according to the present disclosure.

FIGS. 12a and 12b are schematic views of an array substrate after a pattern of a third conductive layer is formed according to the present disclosure.

FIGS. 13a and 13b are schematic views of an array substrate after a pattern of a third insulating layer is formed according to the present disclosure.

FIG. 14 is a schematic diagram of a planar structure of a bonding region and a bezel region in an array substrate according to the present disclosure.

FIGS. 15 to 19 are schematic diagrams of a test circuit for the preparation of the array substrate according to the present disclosure.

FIGS. 20 and 21 are schematic diagrams of short circuit detection by the detection circuit according to the present disclosure.

FIG. 22 is a schematic diagram of detection timing when short circuit detection is performed by the detection circuit according to the present disclosure.

Reference signs are described as follows.

| | | |
|---|---|---|
| 10-thin film transistor; | 20-gate line; | 21-gate electrode; |
| 22-active layer; | 23-source electrode; | 24-drain electrode; |
| 30-data line; | 40-pixel electrode; | 50-touch electrode; |
| 51-electrode part; | 52-connection part; | 53-opening; |
| 60-pixel unit; | 61-first lead; | 61-1-first connection block; |
| 62-second lead; | 62-1-second connection | 70-test unit; |
| | block; | |
| 71-first test line; | 72-second test line; | 73-first data lead; |
| 74- second data lead; | 75-third data lead; | 76-switch control line; |
| 76-1-first control line; | 76-2-second control line; | 76-3-third control line; |
| 76-4-fourth control line; | 76-5-fifth control line; | 81-first connection line; |
| 82-second connection line; | 83-third connection line; | 84-fourth connection line; |
| 85- fifth connection line; | 91-first switch; | 92-second switch; |
| 93-third switch; | 94-fourth switch; | 95-fifth switch; |
| 100-display region; | 111-first gate block; | 112-second gate block; |
| 113-third gate block; | 114-fourth gate block; | 115-fifth gate block; |
| 121-first active layer; | 122-second active layer; | 123-third active layer; |
| 124-fourth active layer; | 125-fifth active layer; | 131-first source electrode; |
| 132-second source electrode; | 133-third source electrode; | 134-fourth source electrode; |
| 135-fifth source electrode; | 141-first drain electrode; | 142-second drain electrode; |
| 143-third drain electrode; | 144-fourth drain electrode; | 145-fifth drain electrode; |
| 151-first lap block; | 152-second lap block; | 153-third lap block; |
| 154-fourth lap block; | 155-fifth lap block; | 161-first lap electrode; |
| 162-second lap electrode; | 163-third lap electrode; | 164-fourth lap electrode; |
| 165-fifth lap electrode; | 200-bonding region; | 210-first test pin; |
| 220-second test pin; | 230-first data pin; | 240-second data pin; |
| 250-third data pin; | 260-switch control pin; | 270-gate line control pin; |
| 280-drive chip; | 300-bezel region; | 310-upper bezel region; |
| 320-side bezel region; | 330-gate drive circuit. | |

### DETAILED DESCRIPTION

Embodiments of the present disclosure will be described in detail hereinafter with reference to the drawings. It is to be noted that the implementation modes may be implemented in various forms. Those of ordinary skills in the art can easily understand such a fact that implementation modes and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

Scales of the drawings in the present disclosure may be used as a reference in actual processes, but are not limited thereto. For example, a width-length ratio of a channel, a thickness and spacing of each film layer, and a width and spacing of each signal line may be adjusted according to actual needs. The quantity of pixels in the array substrate and the quantity of sub-pixels in each pixel are not limited to the quantities shown in the drawings. The drawings described in the present disclosure are schematic structural diagrams only, and one implementation mode of the present disclosure is not limited to the shapes, numerical values or the like shown in the drawings.

Ordinal numerals “first”, “second”, “third”, etc., in the specification are set not to form limits on numbers but only to avoid confusion between composition elements.

In the specification, for convenience, expressions “central”, “above”, “below”, “front”, “back”, “vertical”, “horizontal”, “top”, “bottom”, “inside”, “outside”, etc., indicating directional or positional relationships are used to illustrate positional relationships between the composition elements, not to indicate or imply that involved devices or elements are required to have specific orientations and be structured and operated with the specific orientations but only to easily and simply describe the present specification, and thus should not be understood as limitations on the present disclosure. The positional relationships between the composition elements may be changed as appropriate according to a direction according to which each composition element is described. Therefore, appropriate replacements based on situations are allowed, which is not limited to the expressions in the specification.

In the specification, unless otherwise specified and defined, terms “mounting”, “mutual connection”, and “connection” should be understood in a broad sense. For example, a connection may be fixed connection, or detachable connection, or integral connection; it may be mechanical connection or electrical connection; it may be direct connection, or indirect connection through an intermediate, or internal communication between two elements. Those of ordinary skills in the art can understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, a first electrode may be a drain electrode, and a second electrode may be a source electrode. Or, the first electrode may be a source electrode, and the second electrode may be a drain electrode. In cases that transistors with opposite polarities are used, or a current direction changes during operation of a circuit, or the like, functions of the “source electrode” and the “drain electrode” are sometimes interchangeable. Therefore, the “source electrode” and the “drain electrode”, as well as the “source terminal” and the “drain terminal”, are interchangeable in the specification.

In the specification, a “connection” includes a case where constitute elements are connected together through an element with a certain electrical action. An “element with a certain electrical action” is not particularly limited as long as electric signals between the connected composition elements may be sent and received. Examples of the “element with the certain electrical action” not only include an electrode and a line, but also include a switch element such as a transistor, a resistor, an inductor, a capacitor, another element with various functions, etc.

In the specification, “parallel” refers to a state in which an angle formed by two straight lines is above−10° and below 10°, and thus may include a state in which the angle is above−5° and below 5°. In addition, “perpendicular” refers to a state in which an angle formed by two straight lines is above 80° and below 100°, and thus may include a state in which the angle is above 85° and below 95°.

In the specification, a “film” and a “layer” are interchangeable. For example, a “conductive layer” may be replaced with a “conductive thin film” sometimes. Similarly, an “insulation thin film” may be replaced with an “insulation layer” sometimes.

Triangle, rectangle, trapezoid, pentagon, hexagon, etc. in this specification are not strictly defined, and they may be approximate triangle, rectangle, trapezoid, pentagon, hexagon, etc. There may be some small deformations caused by tolerance, and there may be chamfer, arc edge, deformation, etc.

In the present disclosure, “about” refers to that a boundary is not defined so strictly and numerical values within a range of process and measurement errors are allowed.

A Liquid Crystal Display (LCD for short) has characteristics, such as small volume, low power consumption, and no radiation, and has been widely used. The Liquid Crystal array substrate includes a Thin Film Transistor (TFT for short) array substrate and a Color Filter (CF for short) substrate that are in a form of cell. Liquid Crystal (LC for short) molecules are provided between the array substrate and the color filter substrate. By controlling a common electrode and a pixel electrode, an electric field for driving the liquid crystal to deflect is formed, thereby implementing gray scale display.

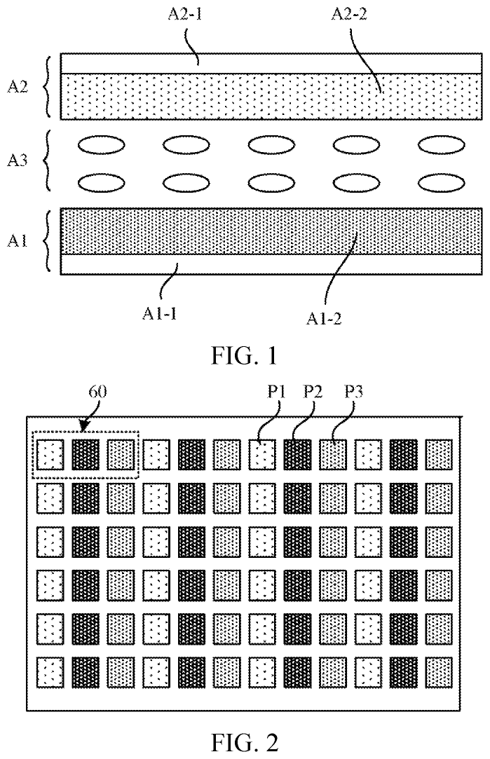

FIG. 1 is a schematic sectional view of a liquid crystal display. As shown in FIG. 1, the liquid crystal display may include a first substrate A1 and a second substrate A2 disposed oppositely, and a liquid crystal layer A3 disposed between the first substrate A1 and the second substrate A2, the first substrate A1 may include a first structural layer A1-2 disposed on a side of a first base substrate A1-1 facing the second substrate A2, the second substrate A2 may include a second structural layer A2-2 disposed on a side of a second base substrate A2-1 facing the first substrate A1. The liquid crystal display can be categorized into Twisted Nematic (TN) display mode, In Plane Switching (IPS) display mode, Fringe Field Switching (FFS) display mode and Advanced Super Dimension Switch (ADS) display mode, in accordance with display mode. For the ADS display mode, in an exemplary implementation, the first structure layer A1-2 may include a gate line, a data line, a thin film transistor, a pixel electrode, and a common electrode, and the second structure layer A2-2 may include a black matrix and a filter unit.

FIG. 2 is a schematic diagram of a planar structure of a liquid crystal display. As shown in FIG. 2, the liquid crystal display may include a plurality of pixel units 60 arranged in a matrix, wherein at least one of the plurality of pixel units 60 may include: a first sub-pixel P1 that emits first-color light, a second sub-pixel P2 that emits second-color light, and a third sub-pixel P3 that emits third-color light. The three sub-pixels may each include a thin film transistor, a pixel electrode and a common electrode. In an exemplary implementation, the first sub-pixel PI may be a red sub-pixel that emits red (R) light rays, the second sub-pixel P2 may be a green sub-pixel that emits green (G) light rays, the third sub-pixel P3 may be a blue sub-pixel that emits blue (B) light rays, a shape of sub-pixels in a pixel unit may be a rectangular shape, a diamond shape, a pentagonal shape, or a hexagonal shape, etc., and the sub-pixels in the pixel unit may be arranged side by side horizontally, side by side vertically, or in mode like a Chinese character “w”. In an exemplary implementation, the pixel unit may include four sub-pixels, which is not limited in the present disclosure.

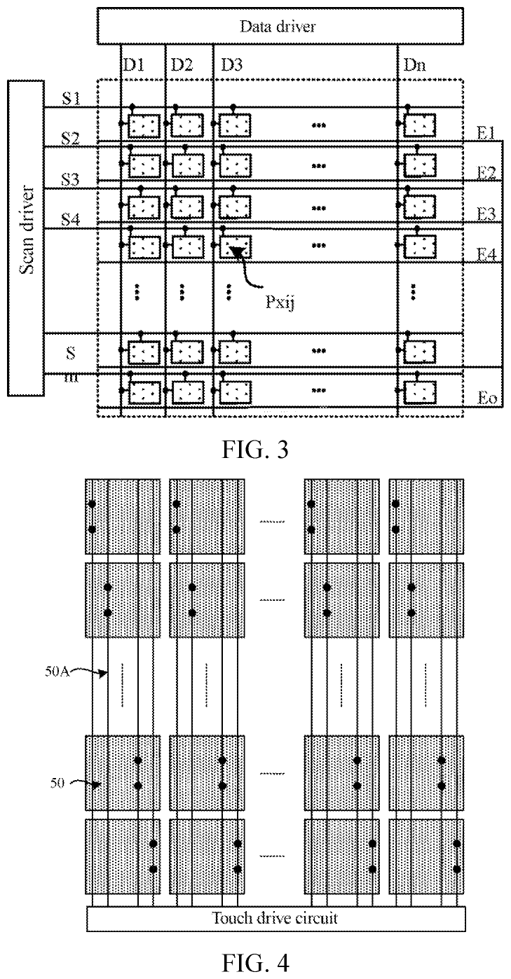

FIG. 3 is a schematic diagram of a planar structure of an array substrate. As shown in FIG. 3, in an exemplary implementation, the array substrate may include a display region and a bezel region, the display region may include a plurality of gate lines (S1 to Sm) and a plurality of data lines (D1 to Dn), wherein the plurality of gate lines may extend along a horizontal direction and be arranged sequentially along a vertical direction, the plurality of data lines may extend along the vertical direction and be arranged sequentially along the horizontal direction, and the plurality of gate lines and the plurality of data lines are intersected with each other to define a plurality of sub-pixels Pxij arranged regularly, where m, n, i and j may be natural numbers. In an exemplary implementation, at least one sub-pixel Pxij may include a thin film transistor, a pixel electrode, and a common electrode, wherein the thin film transistor is connected with a gate line, a data line, and a pixel electrode, respectively.

In an exemplary implementation, the array substrate may also include a plurality of common electrode lines (E1 to Eo), the plurality of common electrode lines may extend along the horizontal direction and be sequentially disposed in the vertical direction or the plurality of common electrode lines may extend in the vertical direction and be sequentially disposed in the horizontal direction, and the plurality of common electrode lines are connected correspondingly with common electrodes in the plurality of sub-pixels Pxij.

In an exemplary implementation mode, the plurality of gate lines are connected to a scan driver, the plurality of data lines are connected to a data driver, and at least part of the scan driver and the data driver may be formed on the array substrate.

In an exemplary implementation, an external control apparatus (such as a timing controller) may provide a gray scale value and a control signal suitable for a specification of the data driver to the data driver, and the data driver may utilize the received gray scale value and the control signal to generate a data voltage to be provided to the data lines D1, D2, D3, . . . , and Dn. For example, the data driver 22 may sample the gray-scale value using the clock signal and apply the data voltage corresponding to the gray-scale value to the data lines DI to Dn by using a sub-pixel row as a unit. The external control apparatus may provide a clock signal, a scan start signal, and the like suitable for a specification of the scan driver to the scan driver, and the scan driver may utilize the clock signal, the scan start signal, and the like to generate a scan signal to be provided to the scan signal lines S1, S2, S3, . . . , and Sm. For example, the scan driver may sequentially provide a scan signal with an on-level pulse to the scan signal lines S1 to Sm. For example, the scan driver may be constructed in a form of a shift register, and may generate a scan signal in a manner of sequentially transmitting a scan start signal provided in a form of an on-level pulse to a next-stage circuit under control of a clock signal.

In an exemplary implementation mode, a liquid crystal display with integrated touch function mainly includes an On Cell structure and an In Cell structure. In the On Cell structure, the touch structure is usually provided on a side of the color filter substrate away from the array substrate, and in the In Cell structure, the touch structure is usually provided in the first structure layer of the array substrate. Compared with the On Cell structure, the In Cell structure can achieve the slimming of the liquid crystal display.

In an exemplary implementation mode, the In Cell structure is mainly divided into a Mutual Capacitance structure and a Self Capacitance structure. In the Mutual Capacitance structure, the drive electrode and the sensing electrode are overlapped with, or are close to, each other to form a mutual capacitance, and the change in the mutual capacitance is utilized for the position detection. In the Self Capacitance structure, the touch electrode and the human body form a self-capacitance, and the change in the self-capacitance is utilized for position detection. Compared with the mutual capacitance structure, the self-capacitance structure is of a single-layer structure, characterized by low power consumption and simple structure.

FIG. 4 is a schematic diagram of a structure of an In-Cell touch screen panel. As shown in FIG. 4, the in-cell touch screen panel (In-Cell Touch LCD) may include a plurality of touch electrodes 50 and a plurality of touch leads (also referred to as sensing signal lines, Tx signal lines) 50A arranged regularly, and each touch electrode 50 is connected to a touch drive circuit through the touch lead 50A. During operation, the touch of a human finger causes a change in the self-capacitance of the corresponding touch control electrode 50, and the touch drive circuit determines the specific position of the finger based on the change in capacitance of the touch control electrode 50. In an exemplary implementation mode, the In-Cell touch screen panel uses a common electrode layer that provides a common voltage as a touch layer, and the common electrode layer is “split” to form block-shaped touch electrodes 50 shown in FIG. 4. In an exemplary implementation mode, a shape of the touch electrode may be a rectangle, a diamond, a triangle or a polygon and the like, which is not limited here in the present disclosure.

In an exemplary implementation mode, the In-Cell touch screen panel shown in FIG. 4 adopts a time-sharing driving operation mode, and the driving signals for the display period and the touch period are separately processed. During the display period, the data lines are supplied with display signals by the data driver, the touch electrodes are reused as common electrodes, the touch signal lines are reused as common electrode lines, the touch signal lines provide common voltage to the touch electrodes, and no touch signal scanning is carried out to ensure normal display. In the touch period, the touch drive circuit performs a touch signal scan through the touch signal lines, at this time, a frame display has been completed, the display state is basically not affected by the touch signal, and the two work independently in time sharing.

In an exemplary implementation mode, a touch electrode may be approximately a 4*4 mm or 5*5 mm rectangle, may cover a plurality of sub-pixels, and is controlled by a single touch lead, which may be disposed between adjacent sub-pixels. Since a touch electrode covers a plurality of sub-pixels, the quantity of touch leads is much less than the quantity of sub-pixels covered by the touch electrode, and thus in order to avoid that touch leads are provided between some sub-pixels and not provided between other sub-pixels, and to ensure the consistency of the pixel structure and etching uniformity, the existing array substrate are usually provided with leads between each adjacent sub-pixel, and part of these leads are used as touch leads for controlling the touch electrode, and the rest are dummy lines, and there is no signal input to the dummy lines.

In recent years, high-resolution display apparatuses have gradually become the development trend of the industry. The resolution of the display apparatus (Pixels Per Inch, PPI for short) is related to the pixel aperture ratio of the array substrate, and the higher the pixel aperture ratio, the higher the resolution of the display apparatus. Through research, it is found that the existing array substrate has problems such as low pixel aperture ratio, which affects the improvement of the resolution of the display apparatus due to the fact that the existing array substrate is provided with touch leads or dummy lines between adjacent sub-pixels, a large number of dummy lines take up the space of sub-pixels.

An exemplary embodiment of the present disclosure provides an array substrate including a display region, the display region includes at least: a plurality of touch electrodes constituting a plurality of touch rows and a plurality of touch columns, and a plurality of pixel units constituting a plurality of pixel rows and a plurality of pixel columns, orthographic projections of the touch units on the array substrate are at least partially overlapped with orthographic projections of the plurality of pixel units on the array substrate, the pixel unit includes a plurality of sub-pixels; a touch lead group is provided between at least one adjacent pixel columns; the touch lead group includes at least a first lead and a second lead provided side by side; the first lead is connected with a touch electrode in a touch row, and the second lead is connected with another touch electrode in an adjacent touch row.

In an exemplary implementation mode, at least one touch column includes N touch electrodes arranged sequentially along a pixel column direction, an orthographic projection of the touch column on the array substrate is at least partially overlapped with an orthographic projection of N/2 pixel columns on the array substrate, the first lead located between an i-th pixel column and an (i+1)-th pixel column is connected to the touch electrodes in an (2i-1)-th touch row, the second lead located between the i-th pixel column and the (i+1)-th pixel column is connected to the touch electrodes in an 2i-th touch row, N is an even number greater than 1, and i is a positive integer greater than or equal to 1 and less than or equal to N/2.

In an exemplary implementation mode, at least one pixel unit includes a first sub-pixel, a second sub-pixel and a third sub-pixel arranged sequentially along a pixel row direction, the sub-pixel includes a gate line, a data line, a thin film transistor and a pixel electrode, the thin film transistor is respectively connected to the gate line, the data line and the pixel electrode, the touch electrode is reused as a common electrode, and the first lead and the second lead are reused as common electrode lines; the first lead is disposed at a side of the third sub-pixel away from the first sub-pixel, and the second lead is disposed at a side of the first lead away from the first sub-pixel.

In an exemplary implementation mode, the array substrate further includes a bonding region located at a side of the display region and an upper bezel region located at a side of the display region away from the bonding region; the bonding region includes at least a plurality of pins, the upper bezel region includes at least a test circuit, the test circuit is correspondingly connected with the plurality of pins of the bonding region through a plurality of connection lines, and the test circuit is configured to detect short circuit defects of the array substrate.

In an exemplary implementation mode, the test circuit includes a plurality of test units corresponding to positions of the plurality of touch columns; at least one test unit includes a first test line, a second test line, a switch control line, a first switch and a second switch; the first test line is connected with the first lead in the display region through the first switch, the second test line is connected with the second lead in the display region through the second switch, and the switch control line is connected with control terminals of the first switch and the second switch; the first test line is configured to transmit a first gray-scale voltage to the first lead under control of the switch control line, and the second test line is configured to transmit a second gray-scale voltage to the second lead under control of the switch control line; a voltage value of the first gray-scale voltage is greater than a voltage value of the second gray-scale voltage, or the voltage value of the first gray-scale voltage is less than the voltage value of the second gray-scale voltage.

In an exemplary implementation mode, the test unit further includes a first data lead, a second data lead, a third data lead, a third switch, a fourth switch, and a fifth switch, the first data lead is connected with a data line of the first sub-pixel in the display region through the third switch, the second data lead is connected with a data line of the second sub-pixel in the display region through the fourth switch, the third data lead is connected with a data line of the third sub-pixel in the display region through the fifth switch, the switch control line is connected with control terminals of the third switch, the fourth switch and the fifth switch; the first data lead, the second data lead, and the third data lead are configured to transmit a common reference voltage to data lines of the display region under control of the switch control line.

FIG. 5 is a schematic diagram of a planar structure of an array substrate according to an exemplary embodiment of the present disclosure. As shown in FIG. 5, the array substrate may include a display region 100, a bonding region 200 located at a side of the display region 100, and a bezel region 300 located at another side of the display region 100. In an exemplary implementation mode, the display region 100 may be a flat region including a plurality of pixel units constituting a pixel array and a plurality of touch electrodes constituting a pixel array, the plurality of pixel units are configured to display a moving picture or a still image and the plurality of touch electrodes are configured to implement touch control. In an exemplary implementation mode, the display region 100 may be referred to as an active region (AA).

In an exemplary implementation mode, the bonding region 200 may include at least a fanout region, a drive chip region and a bonding pin region arranged sequentially in a direction away from the display region, the fanout region may be connected to the display region 100, and may include at least data transmission lines and touch transmission lines, a plurality of data transmission lines are configured to connect data lines of the display region in a fanout trace manner, and a plurality of touch transmission lines are configured to connect touch traces of the display region. The drive chip region may be connected to the fanout region and may include at least an Integrated Circuit (IC) configured to be connected to the plurality of data transmission lines and the plurality of touch transmission lines. The bonging pin region may be connected to the drive chip region and may include at least a plurality of pins (PIN) configured to be bound and connected to an external Flexible Printed Circuit (FPC).

In an exemplary implementation mode, the bezel region 300 may include an upper bezel region 310 located at a side of the display region 100 away from the bonding region 200 and a side bezel region 320 located at two sides of the display region 100. The upper bezel region 310 may include at least a test circuit connected to the plurality of data lines and the touch traces in the display region, the test circuit is configured to detect short circuit defects of the array substrate. The side bezel region 320 may include a circuit region and a lead region that are sequentially disposed in a direction away from the display region 100. The circuit region can be connected with the display region 100 and may at least include multiple cascaded gate drive circuits (GOA) connected to a plurality of gate lines in the display region 100. The lead region may be connected to the circuit region and may include at least a plurality of connection lines, first ends of the plurality of connection lines may be connected to a plurality of pins of the bonding region 200, and second ends of the plurality of connection lines may be connected to a test circuit of the upper bezel region 310, so that an external test apparatus transmits a test signal to the test circuit through the plurality of connection lines.

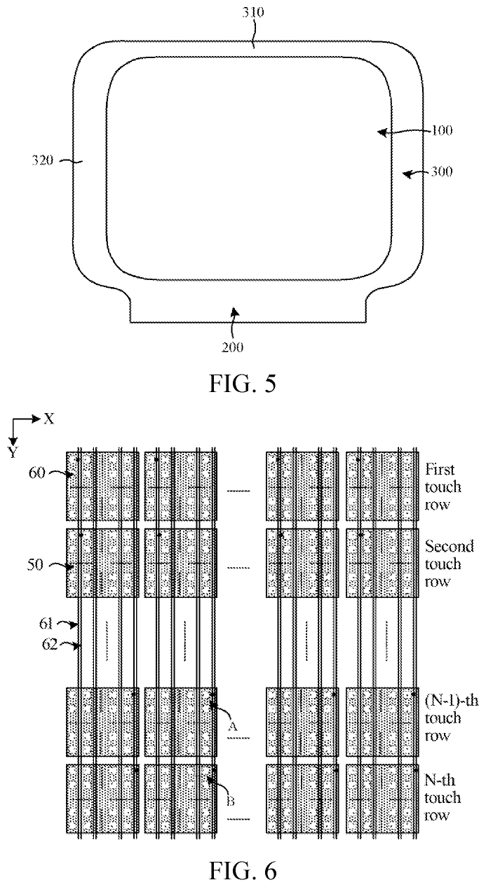

FIG. 6 is a schematic diagram of a planar structure of a display region according to an exemplary embodiment of the present disclosure. As shown in FIG. 6, in an exemplary implementation mode, the display region of the array substrate may include at least a plurality of touch electrodes 50 constituting a plurality of touch rows and a plurality of touch columns and a plurality of pixel units 60 constituting a plurality of pixel rows and a plurality of pixel columns, the plurality of pixel units 60 constitute a pixel array configured to display a moving picture or a still image, and the plurality of touch electrodes 50 constitute a touch array configured to implement touch control. Each touch row may include a plurality of touch electrodes 50 sequentially disposed along a first direction X, the plurality of touch rows may be disposed at intervals along a second direction Y, and each touch column may include a plurality of touch electrodes 50 sequentially disposed along the second direction Y, the plurality of touch columns may be disposed at intervals along the first direction X. Each pixel row may include a plurality of pixel units 60 sequentially disposed along the first direction X, the plurality of pixel rows may be disposed at intervals along the second direction Y, and each pixel column may include a plurality of pixel units 60 sequentially disposed along the second direction Y, the plurality of pixel columns may be disposed at intervals along the first direction X. In an exemplary implementation mode, the first direction X intersects with the second direction Y.

In an exemplary implementation mode, an orthographic projection of at least one touch electrode 50 on the array substrate may include orthographic projections of the plurality of pixel units 60 on the array substrate, i.e., one touch electrode 50 may cover the plurality of pixel units 60, and the pixel unit 60 may include a plurality of sub-pixels.

In an exemplary implementation mode, the display region may include N touch rows, i.e., one touch column may include N touch electrodes 50 arranged sequentially along the second direction Y. An orthographic projection of at least one touch column on the array substrate is at least partially overlapped with orthographic projections of N/2 pixel columns on the array substrate, i.e., the positions of N touch electrodes 50 of one touch column may correspond to the positions of a plurality of pixel units 60 of N/2 pixel columns, N is an even number greater than 1.

In an exemplary implementation mode, among N/2 pixel columns corresponding to one touch column, a touch lead group is disposed between at least one adjacent pixel columns. In an exemplary implementation mode, the touch lead group may include a first lead 61 and a second lead 62. The first lead 61 and the second lead 62 may be in a shape of a line extending along the second direction Y (a pixel column direction), and the second lead 62 may be provided at a side of the first lead 61 in the first direction X (a pixel row direction).

In an exemplary implementation mode, for the first lead 61 and the second lead 62 located between the i-th pixel column and the (i+1)-th pixel column, the first lead 61 may be connected to a touch electrode 50 in the (2i-1)-th touch row, and the second lead 62 may be connected to a touch electrode 50 in the 2i-th touch row, where i is a positive integer greater than or equal to 1 and less than or equal to N/2.

In an exemplary implementation mode, when a plurality of first leads 61 are connected to touch electrodes 50 in an odd-numbered touch row, a plurality of second leads 62 are connected to touch electrodes 50 in an even-numbered touch row. When a plurality of first leads 61 are connected to touch electrodes 50 in an even-numbered touch row, a plurality of second leads 62 are connected to touch electrodes 50 in an odd-numbered touch row.

In an exemplary implementation mode, for a first touch column on the left shown in FIG. 6, the touch column corresponds to N/2 pixel columns. For the first lead 61 and the second lead 62 between a first pixel column and a second pixel column, the first lead 61 is connected to a first touch electrode 50 of this touch column (a touch electrode 50 of a first touch row), and the second lead 62 is connected to a second touch electrode 50 of this touch column (a touch electrode 50 of a second touch row). For the first lead 61 and the second lead 62 between the second pixel column and a third pixel column, the first lead 61 is connected to a third touch electrode 50 of this touch column (a touch electrode 50 of a third touch row), and the second lead 62 is connected to a fourth touch electrode 50 of this touch column (a touch electrode 50 of a fourth touch row). For the first lead 61 and the second lead 62 between an (N/2)-th pixel column and an (N/2+1)-th pixel column, the first lead 61 is connected to an (N-1)-th touch electrode 50 of this touch column (a touch electrode 50 of an (N-1)-th touch row), and the second lead 62 is connected to an N-th touch electrode 50 of this touch column (a touch electrode 50 of an N-th touch row). The (N/2+1)-th pixel column is the first pixel column corresponding to a second touch column.

In an exemplary implementation mode, one pixel unit 60 may include 3 sub-pixels or may include 4 sub-pixels. By taking a case in which the pixel unit 60 includes a first sub-pixel, a second sub-pixel, and a third sub-pixel arranged sequentially along the first direction X as an example, the first lead 61 and the second lead 62 may be arranged between the third sub-pixel of the i-th pixel column and the first sub-pixel of the (i+1)-th pixel column, and neither the first lead nor the second lead is provided between the first sub-pixel and the second sub-pixel, and between the second sub-pixel and the third sub-pixel in each pixel column.

In an exemplary implementation mode, the display region may include a plurality of touch columns, and each touch column and corresponding multiple pixel columns may have the same structure as the first touch column.

In an exemplary implementation mode, on a plane perpendicular to the array substrate, the array substrate may include a base substrate and a plurality of conductive layers disposed on the base substrate, the first lead 61 and the second lead 62 may be disposed in a same conductive layer, the touch electrode 50 may be disposed in another conductive layer, and the first lead 61 and the second lead 62 may be connected to the touch electrode 50 through a via.

In an array substrate, a lead is generally provided between every adjacent sub-pixels, i.e., three leads are provided in a pixel unit including three sub-pixels, some of which serve as touch leads and others as dummy lines. Since each lead will occupy the space of sub-pixels, the array substrate of this structure has the problems such as a low pixel aperture ratio, which affects the improvement of the resolution of the display apparatus. In the array substrate according to an exemplary embodiment of the present disclosure, two touch leads are provided between adjacent pixel units, so that one pixel unit only includes two touch leads. Compared with providing 3 leads in a pixel unit, the present disclosure not only reduces the quantity of leads, increases the space of sub-pixels, improves the pixel aperture ratio, but also improves the light transmittance of the array substrate, which is favorable to the improvement of the resolution of the display apparatus. Moreover, since each lead is connected with a corresponding touch electrode through a via, the consistency of the pixel structure and the etching uniformity are ensured, which is beneficial to the improvement of the quality of the preparation process.

In an exemplary implementation mode, the structure shown in FIG. 6 is only an exemplary description and corresponding structures may be changed according to actual needs. For example, the touch lead group may include 3 touch leads or a plurality of touch leads. Since the existing array substrate is provided with 3 leads between sub-pixels respectively, while the present disclosure provides 3 touch leads between adjacent pixel units, the space of sub-pixels can likewise be increased, and the pixel aperture ratio can be improved, which is beneficial to the improvement of the resolution of the display apparatus. As another example, 2 pixel units or a plurality of pixel units may be used as a repeating unit, and the touch lead group may be provided between adjacent repeating units, which is not limited here in the present disclosure.

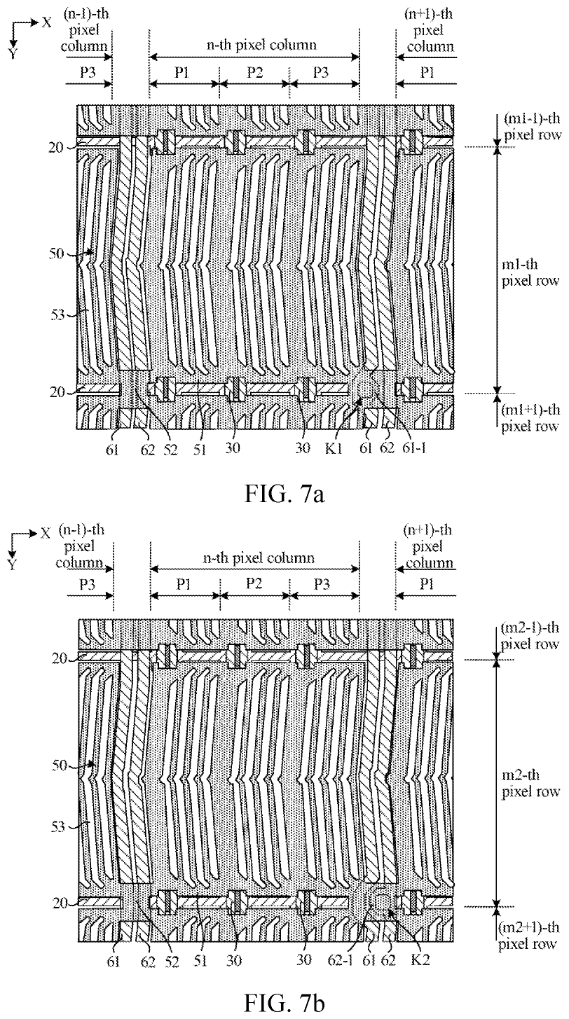

FIG. 7a is an enlarged view of a region A in FIG. 6, and FIG. 7b is an enlarged view of a region B in FIG. 6. A pixel units in the region A is a pixel unit at the cross-point of an m1-th pixel row and an n-th pixel column, and a pixel unit in the region B is a pixel unit at the cross-point of an m2-th pixel row and the n-th pixel column. The pixel units in the region A and the pixel units in the region B both include a first sub-pixel P1, a second sub-pixel P2 and a third sub-pixel P3 sequentially provided in the first direction X.

In an exemplary implementation mode, the display region of the array substrate may include at least a plurality of gate lines 20 and a plurality of data lines 30, the gate lines 20 are in a shape of a line extending along the first direction X, the plurality of gate lines 20 may be arranged sequentially along the second direction Y, the data lines 30 are in a shape of a line extending along the second direction Y, the plurality of data lines 30 may be arranged sequentially along the first direction X, the plurality of gate lines 20 and the plurality of data lines 30 intersecting with each other define a plurality of sub-pixels in a regular arrangement, each sub-pixel is provided with a thin film transistor and a pixel electrode, and the thin film transistor may be connected to the gate line 20, the data line 30 and the pixel electrode, respectively.

In an exemplary implementation mode, the display region of the array substrate may also include a plurality of touch lead groups reused as common electrode lines and a plurality of touch electrodes 50 reused as common electrodes. The touch lead groups may be disposed between pixel units adjacent in the first direction X, and at least one touch lead group may include at least a first lead 61 and a second lead 62 provided side by side, the first lead 61 and the second lead 62 are respectively connected to corresponding touch electrodes 50.

In an exemplary implementation mode, the thin film transistor in each sub-pixel is configured to, under control of the gate line 20, receive a data voltage transmitted by the data line 30 and output it to the pixel electrode, and control the formation of an electric field between the pixel electrode and the common electrode that drives the deflection of the liquid crystal and realize gray scale display.

In an exemplary implementation mode, the first and second leads 61 and 62 may be in a shape of a bending line extending along the second direction Y. In one pixel row (e.g., the m1-th pixel row), the first lead 61 may be connected to one touch electrode 50 through a first via K1. In another pixel row (e.g., the m2-th pixel row), the second lead 62 may be connected to another touch electrode 50 through a second via K2.

In an exemplary implementation mode, in one pixel row, a first connection block 61-1 may be provided on the first lead 61, and the first connection block 61-1 may be connected to a corresponding touch electrode 50 through the first via K1.

In an exemplary implementation mode, in one pixel row, the first lead 61 may include a first straight line segment, a second straight line segment, and a bending segment between the first straight line segment and the second straight line segment, a first end of the bending segment is connected to the first straight line segment, a second end of the bending segment is connected to the second straight line segment, a middle part of the bending segment may protrude in a direction away from the second lead 62, and the first connection block 61-1 may be disposed at a side of the bending segment close to the second lead 62, i.e., the first connection block 61-1 may be disposed in a region formed by the bending of the bending segment.

In an exemplary implementation mode, in another pixel row, a second connection block 62-1 may be provided on the second lead 62, and the second connection block 62-1 may be connected to another touch electrode 50 through the second via K2.

In an exemplary implementation mode, in another pixel row, the first lead 61 may include a first straight line segment, a second straight line segment, and a bending segment located between the first straight line segment and the second straight line segment, a first end of the bending segment is connected to the first straight line segment, a second end of the bending segment is connected to the second straight line segment, and a middle part of the bending segment may protrude in a direction away from the second lead 62, so that the second connection block 62-1 may be disposed in a region formed by the bending of the bending segment.

In an exemplary implementation mode, an orthographic projection of the first connection block 61-1 on the base substrate is at least partially overlapped with an orthographic projection of the gate line 20 on the base substrate, and an orthographic projection of the second connection block 62-1 on the base substrate is at least partially overlapped with the orthographic projection of the gate line 20 on the base substrate.

In an exemplary implementation mode, a touch electrode 50 in at least one pixel unit may include an electrode part 51 and a connection part 52, the electrode part 51 may be disposed within the pixel unit, the connection part 52 may be disposed between adjacent pixel units and connected with the electrode parts 51 within the adjacent pixel units, to connect a plurality of electrode parts 51 within a plurality of pixel units into a whole.

In an exemplary implementation mode, the connection part 52 may be disposed between pixel units adjacent in the first direction X, or the connection part 52 may be disposed between pixel units adjacent in the second direction Y, or the connection part 52 may be disposed between pixel units adjacent in the first direction X and between pixel units adjacent in the second direction Y.

In an exemplary implementation mode, an orthographic projection of the electrode part 51 on the base substrate is not overlapped with the orthographic projection of the gate line 20 on the base substrate, the orthographic projection of the electrode part 51 on the base substrate is not overlapped with an orthographic projection of the first lead 61 on the base substrate, and the orthographic projection of the electrode part 51 on the base substrate is not overlapped with an orthographic projection of the second lead 62 on the base substrate.

In an exemplary implementation mode, an orthographic projection of the connection part 52 on the base substrate is at least partially overlapped with the orthographic projection of the gate line 20 on the base substrate, the orthographic projection of the connection part 52 on the base substrate is at least partially overlapped with the orthographic projection of the first lead 61 on the base substrate, and the orthographic projection of the connection part 52 on the base substrate is at least partially overlapped with the orthographic projection of the second lead 62 on the base substrate.

In an exemplary implementation mode, at least one connection part 52 of one touch electrode 50 is connected to the first lead 61 through the first via K1, and at least one connection part 52 of another touch electrode 50 is connected to the second lead 62 through the second via K2.

In an exemplary implementation mode, an orthographic projection of the first via Kl on the base substrate is at least partially overlapped with the orthographic projection of the gate line 20 on the base substrate, and an orthographic projection of the second via K2 on the base substrate is at least partially overlapped with the orthographic projection of the gate line 20 on the base substrate.

In an exemplary implementation mode, at least one opening 53 may be provided on the electrode part 51 in the pixel unit, and the opening 53 may be in a shape of a bending line extending along the second direction Y, so that the electrode part 51 forms a plurality of strip-shaped electrodes spaced apart along the first direction X, which may ensure that a horizontal electric field is formed between a planar pixel electrode 40 and a strip-shaped common electrode (a touch electrode).

Exemplary description is made below through a process of manufacturing an array substrate. A “patterning process” mentioned in the present disclosure includes photoresist coating, mask exposure, development, etching, photoresist stripping, etc., for a metal material, an inorganic material, or a transparent conductive material, and includes organic material coating, mask exposure, development, etc., for an organic material. Deposition may be any one or more of sputtering, evaporation, and chemical vapor deposition, coating may be any one or more of spray coating, spin coating, and inkjet printing, and etching may be any one or more of dry etching and wet etching, the present disclosure is not limited thereto. A “thin film” refers to a layer of thin film made of a certain material on a base substrate using deposition, coating, or other processes. If the “thin film” does not need to be processed through a patterning process in the entire manufacturing process, the “thin film” may also be called a “layer”. If the “thin film” needs to be processed through the patterning process in the entire manufacturing process, the “thin film” is called a “thin film” before the patterning process is performed and is called a “layer” after the patterning process is performed. At least one “pattern” is contained in the “layer” which has been processed through the patterning process. “A and B being arranged on the same layer” in the present disclosure means that A and B are formed simultaneously through a same patterning process, and the “thickness” of a film layer is dimension of the film layer in a direction perpendicular to the array substrate. In an exemplary implementation of the present disclosure, “an orthographic projection of B being within a range of an orthographic projection of A” or “an orthographic projection of A containing an orthographic projection of B” means that a boundary of the orthographic projection of B falls within a range of a boundary of the orthographic projection of A, or the boundary of the orthographic projection of A is overlapped with the boundary of the orthographic projection of B.

In an exemplary implementation mode, the preparation of the array substrate may include following operations.

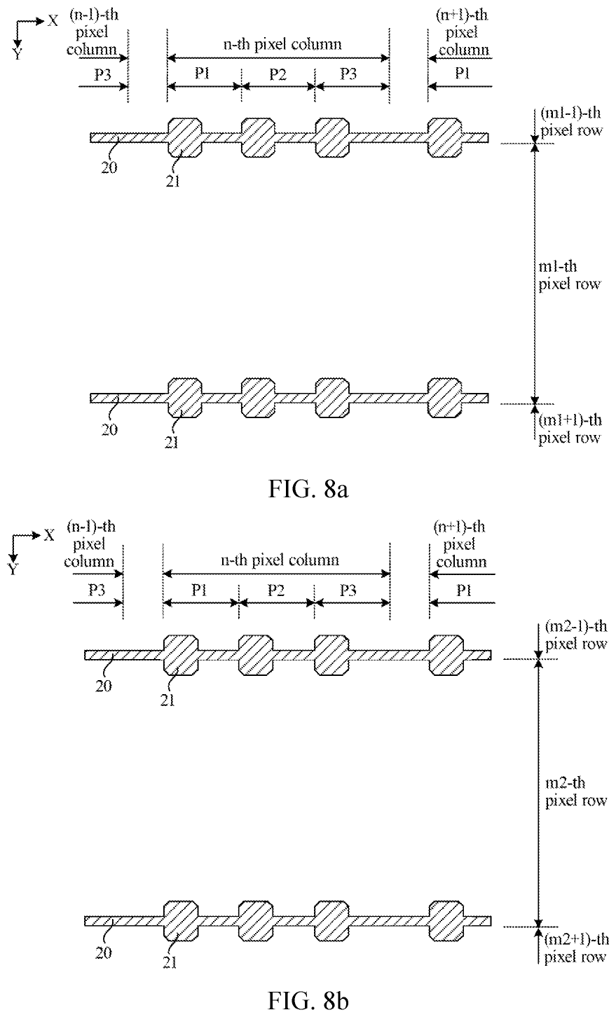

(1) A pattern of a first conductive layer is formed. In an exemplary implementation mode, forming a pattern of a first conductive layer may include: depositing a first conductive thin film on a base substrate, patterning the first conductive thin film by a patterning process to form the pattern of the first conductive layer on the base substrate, the pattern of the first conductive layer includes at least a gate line 20 and a gate electrode 21, as shown in FIGS. 8a and 8b, where FIG. 8a is an enlarged view of a region A in FIG. 6, and FIG. 8b is an enlarged view of a region B in FIG. 6.

In an exemplary implementation mode, the gate line 20 may be in a shape of a straight line in which a main body portion extends along the first direction X, and the gate line 20 of each sub-pixel may be disposed at a side of the sub-pixel in the second direction Y (a position in the sub-pixel close to a next row of sub-pixels), and the gate line 20 is configured to be connected to a thin film transistor in the sub-pixel to provide a scan signal to the thin film transistor.

In an exemplary implementation mode, the gate electrode 21 may be rectangular, the gate electrode 21 may be provided in each sub-pixel and connected to the gate line 20, which is equivalent to the widening design of the gate line 20 in a region where the transistor is formed, so that an overlapping region between the gate line 20 and a data line formed subsequently is small, the parasitic capacitance between the gate line 20 and the data line can be reduced, to improve the electrical performance of the array substrate.

In an exemplary implementation mode, the gate line 20 and the gate electrodes 21 in a plurality of sub-pixels may be of an interconnected integral structure.

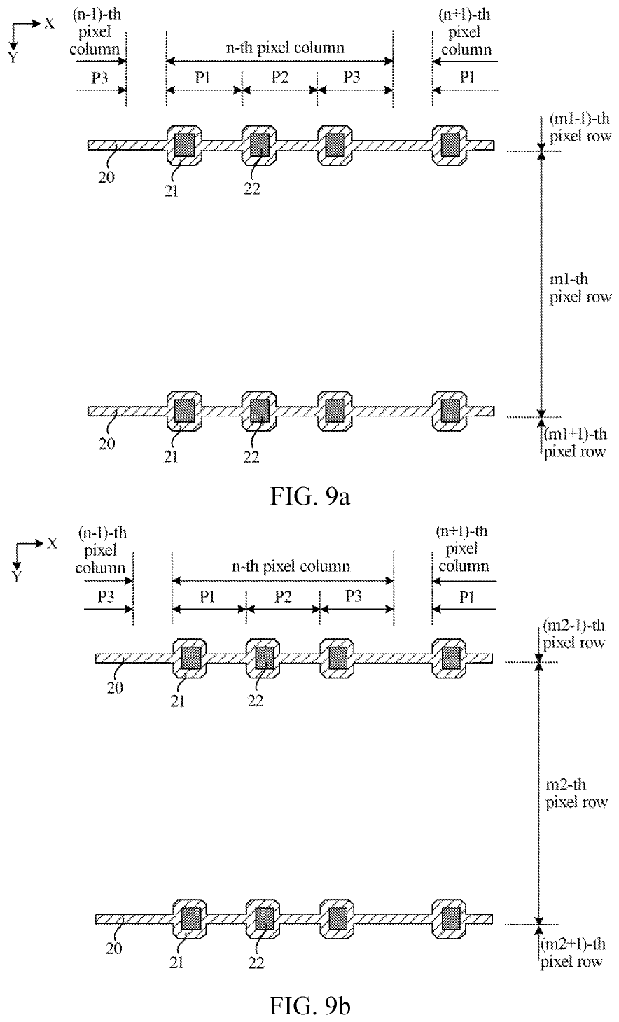

(2) A pattern of a semiconductor layer is formed. In an exemplary implementation mode, forming a pattern of a semiconductor layer may include: sequentially depositing a first insulating thin film and a semiconductor layer thin film on the base substrate on which the above-mentioned pattern is formed, patterning the semiconductor layer thin film by a patterning process to form a first insulating layer covering the pattern of the first conductive layer, and a pattern of a semiconductor layer disposed on the first insulating layer, as shown in FIGS. 9a and 9b, wherein FIG. 9a is an enlarged view of a region A in FIG. 6, and FIG. 9b is an enlarged view of a region B in FIG. 6.

In an exemplary implementation mode, the pattern of the semiconductor layer includes at least an active layer 22 disposed within each sub-pixel and an orthographic projection of the active layer 22 on the base substrate may be within a range of the orthographic projection of the gate electrode 21 on the base substrate.

In an exemplary implementation, the shape and position of an active layer 22 in each sub-pixel may be the same, and the structure of the thin film transistor may be simplified.

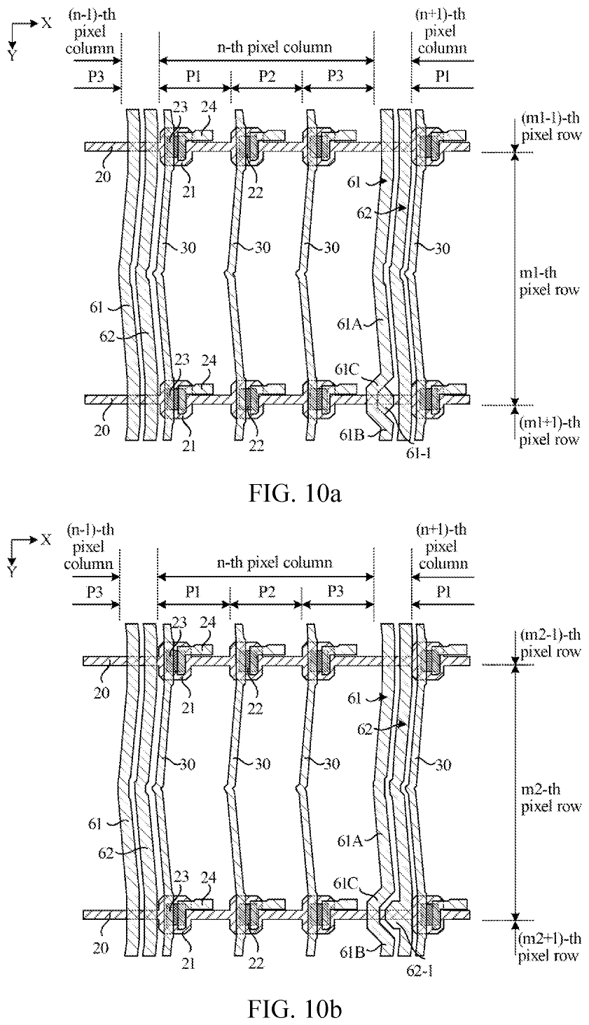

(3) A pattern of a second conductive layer is formed. In an exemplary implementation mode, forming a pattern of a second conductive layer may include: depositing a second conductive thin film on the base substrate on which the above-mentioned patterns are formed, patterning the second conductive thin film by a patterning process to form a pattern of a second conductive layer, as shown in FIGS. 10a and 10b, wherein FIG. 10a is an enlarged view of a region A in FIG. 6, and FIG. 10b is an enlarged view of a region B in FIG. 6.

In an exemplary implementation mode, the pattern of the second conductive layer includes at least a source electrode 23, a drain electrode 24, a data line 30, a first lead line 61 and a second lead line 62.

In an exemplary implementation mode, the data line 30, the first lead line 61, and the second lead line 62 may be in a shape of a bending line in which a main body portion extends along the second direction Y, and the extension directions of each bending line of the data line 30, the first lead line 61, and the second lead line 62 may be substantially the same.

In an exemplary implementation mode, a data line 30 is provided in each sub-pixel, the data line 30 may be provided at a side (a left side) of each sub-pixel in an opposite direction of the first direction X, and the data line 30 is configured to be connected to a thin film transistor in the sub-pixel to provide a data signal to the thin film transistor.

In an exemplary implementation mode, the source electrode 23 and the drain electrode 24 may be disposed in each sub-pixel, a portion of the data line 30 serves as the source electrode 23 of each sub-pixel, the drain electrode 24 of each sub-pixel may be in a shape of an individually provided “L”, the source electrode 23 is connected to the active layer 22, a first end of the drain electrode 24 is connected to the active layer 22, a second end of the drain electrode 24 extends in a direction away from the active layer 22, and is configured to be connected to a subsequently formed pixel electrode, and a conductive channel is formed between the source electrode 23 and the drain electrode 24.

In an exemplary implementation mode, the gate electrode 21, the active layer 22, the source electrode 23, and the drain electrode 24 in each sub-pixel constitute a thin film transistor, the gate electrode 21 is connected to the gate line, the source electrode 23 is connected to the data line 30, and the drain electrode 24 is connected to the pixel electrode.

In an exemplary implementation mode, the first lead 61 and the second lead 62 may be disposed between pixel units adjacent in the first direction X. The first lead 61 and the second lead 62 are configured to be connected to a touch electrode formed subsequently (reused as a common electrode) to supply a touch signal or a common voltage signal to the touch electrode.

In an exemplary implementation mode, the first lead 61 and the second lead 62 may be disposed between the (n−1)-th pixel column and the n-th pixel column and between the n-th pixel column and the (n+1)-th pixel column. For the n-th pixel column, the first lead 61 may be provided at a side of the third sub-pixel P3 away from the first sub-pixel P1, and the second lead 62 may be provided at a side of the first lead 61 away from the first sub-pixel P1.

As shown in FIG. 10a, in the m1-th pixel row, the shape of the first lead 61 between the n-th pixel column and the (n+1)-th pixel column is different from the shape of the first lead 61 between other adjacent pixel columns and the shape of the second lead 62 is substantially the same as the shape of the second lead 62 between other adjacent pixel columns.

In an exemplary implementation mode, the first lead 61 may include a first straight line segment 61A, a second straight line segment 61B, and a bending segment 61C positioned between the first straight line segment 61A and the second straight line segment 61B, and the first lead 61 is provided with a first connection block 61-1 configured to be connected with a subsequently formed touch electrode through a via.

In an exemplary implementation mode, a first end of the bending segment 61C is connected to the first straight line segment 61A, a second end of the bending segment 61C is connected to the second straight line segment 61B, a middle part of the bending segment 61C may protrude toward an opposite direction of the first direction X (a direction away from the second lead 62), and the first connection block 61-1 is disposed at a side of the bending segment 61C in the first direction X (a direction close to the second lead 62), that is, the first connection block 61-1 is disposed in an region formed by the bending of the bending segment 61C.

In an exemplary implementation mode, the first straight line segment 61A, the second straight line segment 61B, the bending segment 61C and the first connection block 61-1 may be of an interconnected integral structure.

In an exemplary implementation mode, an orthographic projection of the bending segment 61C on the base substrate is at least partially overlapped with the orthographic projection of the gate line 20 on the base substrate, and an orthographic projection of the first connection block 61-1 on the base substrate is at least partially overlapped with the orthographic projection of the gate line 20 on the base substrate, so that a connection point of the first lead line 61 with the touch electrode is located in a non-opening region of the sub-pixel to improve the aperture ratio of the sub-pixel.

As shown in FIG. 10b, in the m2-th pixel row, the shape of the first lead 61 between the n-th pixel column and the (n+1)-th pixel column is different from the shape of the first lead 61 between other adjacent pixel columns and the shape of the second lead 62 is different from the shape of the second lead 62 between other adjacent pixel columns.

In an exemplary implementation mode, the second lead 62 may be provided with a second connection block 62-1 configured to be connected to another touch electrode formed subsequently through a via. The second connection block 62-1 may be provided at a side of the second lead 62 in an opposite direction of the first direction X (in a direction toward the first lead 61), and the second connection block 62-1 may be in a shape of a trapezoid protruding in a direction toward the first lead 61.

In an exemplary implementation mode, the first lead 61 may include a first straight line segment 61A, a second straight line segment 61B, and a bending segment 61C located between the first straight line segment 61A and the second straight line segment 61B. A first end of the bending segment 61C is connected to the first straight line segment 61A, a second end of the bending segment 61C is connected to the second straight line segment 61B, and a middle part of the bending segment 61C may protrude in an opposite direction of the first direction X, so that the second connection block 62-1 may be disposed in an region formed by the bending of the bending segment 61C.

In an exemplary implementation mode, an orthographic projection of the second connection block 62-1 on the base substrate is at least partially overlapped with the orthographic projection of the gate line 20 on the base substrate, such that a connection point of the second lead line 61 with the touch electrode is located in a non-opening region of the sub-pixel to improve the aperture ratio of the sub-pixel.

In an exemplary implementation mode, the first straight line segment 61A, the second straight line segment 61B and the bending segment 61C may be of an interconnected integral structure.

In an exemplary implementation mode, the second lead 62 and the second connection block 62-1 may be of an interconnected integral structure.

In an exemplary implementation mode, the shapes of the first straight line segments 61A, the second straight line segments 61B, and the bending segments 61C in the m1-th pixel row and the m2-th pixel row in the first lead 61 located between the n-th pixel column and the (n+1)-th pixel column may be substantially the same.

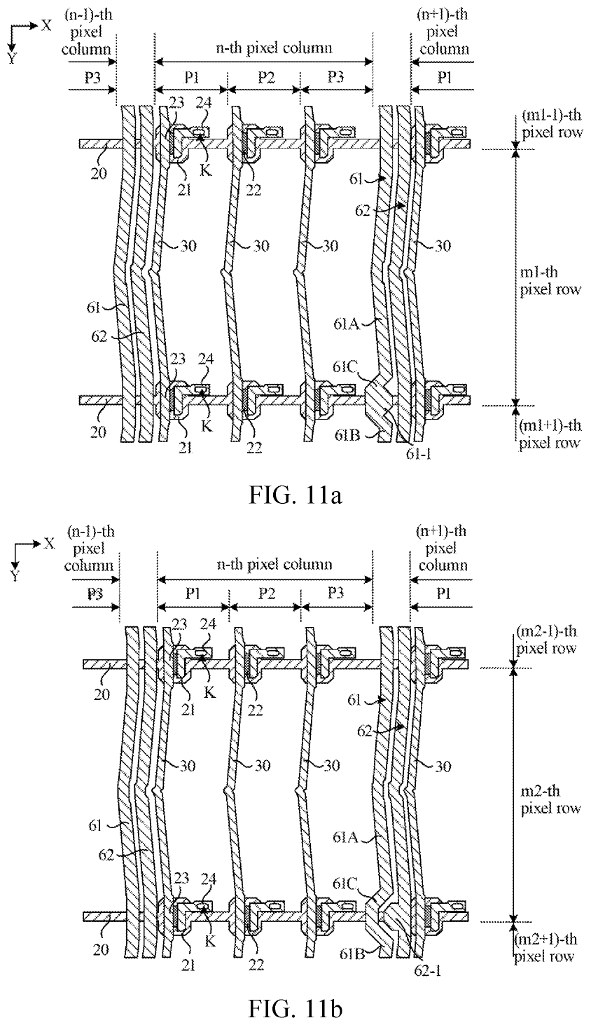

(4) A pattern of a second insulation layer is formed. In an exemplary implementation mode, forming a pattern of a second insulating layer may include: depositing a second insulating thin film on the base substrate on which the above-mentioned patterns are formed, patterning the second insulating thin film by a patterning process to form a pattern of a second insulating layer covering the pattern of the second conductive layer, the second insulating layer has a plurality of vias formed thereon, as shown in FIGS. 11a and 11b, wherein FIG. 11a is an enlarged view of a region A in FIG. 6, and FIG. 11b is an enlarged view of a region B in FIG. 6.

In an exemplary implementation mode, the plurality of vias may include at least a connection via K provided in each sub-pixel. An orthographic projection of the connection via K on the base substrate may be within a range of an orthographic projection of the drain electrode 24 on the base substrate. The second insulating layer in the connection via K is etched away to expose a surface of the drain electrode 24. The connection via K is configured such that a subsequently formed pixel electrode is connected with the drain electrode 24 through the via.

In an exemplary implementation, a shape of the connection via K may include any one or more of: square, rectangle, round and ellipse.

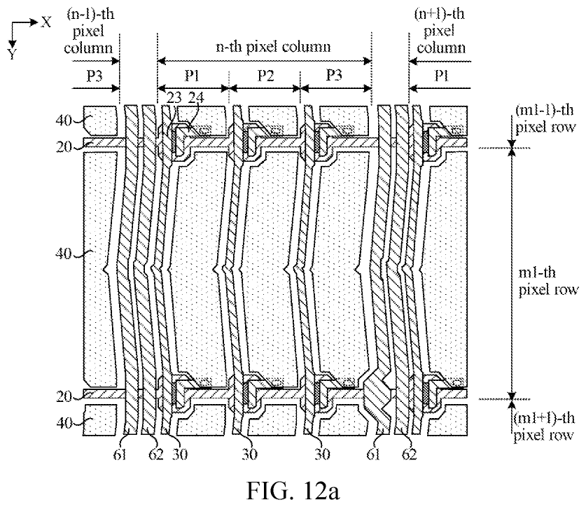

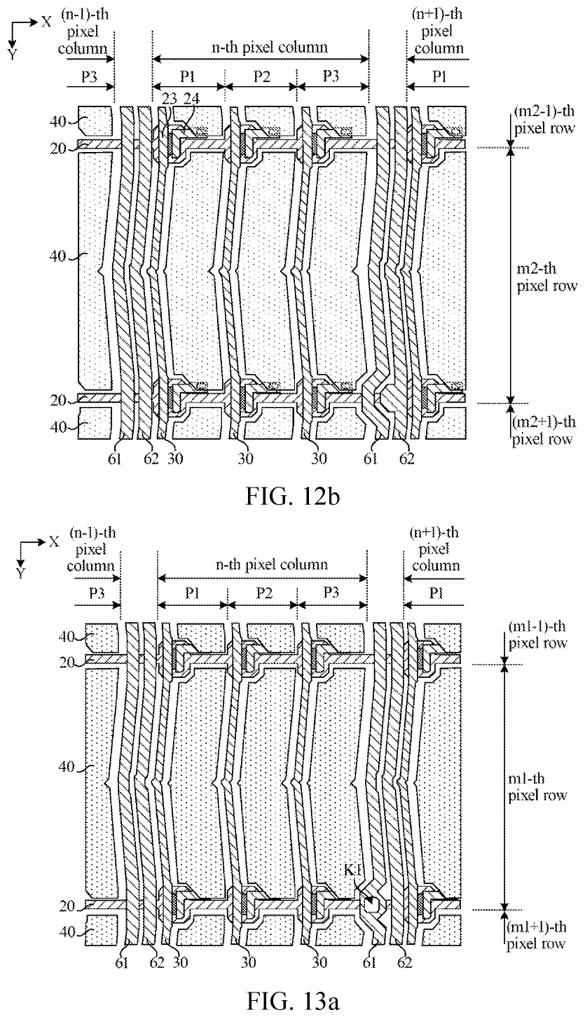

(5) A pattern of a third conductive layer is formed. In an exemplary implementation, forming the pattern of the third conductive layer may include: depositing a third conductive thin film on a base substrate on which the aforementioned patterns are formed, patterning the third conductive thin film by a patterning process to form a pattern of a third conductive layer on the second insulating layer, as shown in FIGS. 12a and 12b, wherein FIG. 12a is an enlarged view of a region A in FIG. 6, and FIG. 12b is an enlarged view of a region B in FIG. 6.

In an exemplary implementation mode, the pattern of the third conductive layer may include at least pixel electrodes 40 disposed in each sub-pixel.

In an exemplary implementation mode, the pixel electrode 40 in each sub-pixel may be in a shape of a full surface, located in an region enclosed by the gate line 20 and the data line 30, and an orthographic projection of the pixel electrode 40 on the base substrate is at least partially overlapped with an orthographic projection of the drain electrode 24 on the base substrate, and the pixel electrode 40 is connected to the drain electrode 24 of the thin film transistor through the connection via K.

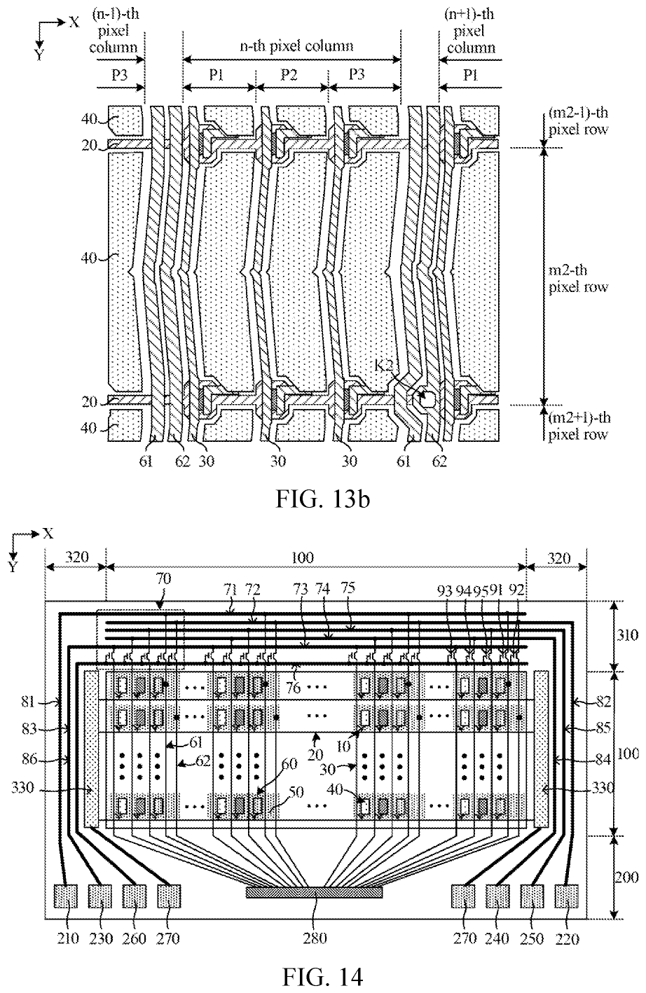

(6) A pattern of a third insulation layer is formed. In an exemplary implementation mode, forming a pattern of a third insulating layer may include: depositing a third insulating thin film on the base substrate on which the above-mentioned patterns are formed, patterning the third insulating thin film by a patterning process to form a pattern of a third insulating layer covering the pattern of the third conductive layer, the third insulating layer has a plurality of vias formed thereon, as shown in FIGS. 13a and 13b, where FIG. 13a is an enlarged view of a region A in FIG. 6, and FIG. 13b is an enlarged view of a region B in FIG. 6.

In an exemplary implementation mode, the plurality of vias may include at least a first via K1 disposed at the cross-point of the m1-th pixel row and the n-th pixel column and a second via K2 disposed at the cross-point of the m2-th pixel row and the n-th pixel column.

In an exemplary implementation mode, an orthographic projection of the first via K1 on the base substrate may be within a range of an orthographic projection of the first connection block 61-1 of the first lead 61 on the base substrate, the second insulating layer and the third insulating layer in the first via K1 are etched away to expose a surface of the first connection block 61-1, and the first via K1 is configured such that a subsequently formed touch electrode is connected with the first connection block 61-1 through the via.

In an exemplary implementation mode, the orthographic projection of the first via K1 on the base substrate is at least partially overlapped with the orthographic projection of the gate line 20 on the base substrate such that a connection point of the first lead 61 with the touch electrode is located in a non-opening region of the sub-pixel to improve the aperture ratio of the sub-pixel.

In an exemplary implementation mode, an orthographic projection of the second via K2 on the base substrate may be within a range of an orthographic projection of the second connection block 62-1 of the second lead 62 on the base substrate, the second insulating layer and the third insulating layer in the second via K2 are etched away to expose a surface of the second connection block 62-1, and the second via K2 is configured such that another touch electrode formed subsequently is connected with the second connection block 62-1 through the via.

In an exemplary implementation mode, the orthographic projection of the second via K2 on the base substrate is at least partially overlapped with the orthographic projection of the gate line 20 on the base substrate such that a connection point of the second lead 62 with the touch electrode is located in the non-opening region of the sub-pixel to improve the aperture ratio of the sub-pixel.

In an exemplary implementation, shapes of the first via Kl and the second via K2 may include any one or more of: square, rectangle, round and ellipse.

(7) A pattern of a fourth conductive layer is formed. In an exemplary implementation mode, forming a pattern of a fourth conductive layer may include: depositing a fourth conductive thin film on the base substrate on which the above-mentioned patterns are formed, patterning the fourth conductive thin film by a patterning process to form a pattern of a fourth conductive layer on the third insulating layer, as shown in FIGS. 7a and 7b.

In an exemplary implementation mode, the pattern of the fourth conductive layer includes at least a plurality of touch electrodes 50 arranged regularly, and the plurality of touch electrodes 50 are reused as common electrodes.

In an exemplary implementation mode, the touch electrode 50 covering the cross-point of the m1-th pixel row and the n-th pixel column is connected to the first connection block 61-1 through the first via K1. Since the first connection block 61-1 is connected to the first lead 61, a connection of the first lead 61 with a touch electrode 50 is achieved, the first lead 61 can supply a touch signal or a common voltage signal to the touch electrode 50.

In an exemplary implementation mode, the touch electrode 50 covering the cross-point of the m2-th pixel row and the n-th pixel column is connected to the second connection block 62-1 through the second via K2. Since the second connection block 62-1 is connected to the second lead 62, a connection of the second lead 62 to another touch electrode 50 is achieved, the second lead 62 may provide a touch signal or a common voltage signal to the touch electrode 50.

In an exemplary implementation mode, in at least one pixel unit, the touch electrode 50 may include an electrode part 51 and a connection part 52, and the electrode part 51 may be disposed within the pixel unit, that is, the electrode part 51 may be disposed within an region surrounded by the first lead 61, the second lead 62 and two gate lines 20. The connection parts 52 may be provided between adjacent pixel units and connected to the electrode parts 51 in the adjacent pixel units so as to connect a plurality of electrode parts 51 in a plurality of pixel units into a whole to form a block-shaped touch electrode 50.

In an exemplary implementation mode, the connection parts 52 may be provided between pixel units adjacent in the first direction X to connect a plurality of electrode parts 51 in one pixel row into a whole, or the connection parts 52 may be provided between pixel units adjacent in the second direction Y to connect a plurality of electrode parts 51 in one pixel column into a whole, or the connection parts 52 may be provided between pixel units adjacent in the first direction X and between pixel units adjacent in the second direction Y to connect a plurality of electrode parts 51 in a plurality of pixel rows and a plurality of pixel columns into a whole.

In an exemplary implementation mode, an orthographic projection of the electrode part 51 on the base substrate is not overlapped with the orthographic projection of the gate line 20 on the base substrate, the orthographic projection of the electrode part 51 on the base substrate is not overlapped with an orthographic projection of the first lead line 61 on the base substrate, and the orthographic projection of the electrode part 51 on the base substrate is not overlapped with an orthographic projection of the second lead line 62 on the base substrate, to reduce the influence of signals transmitted by the gate line 20, the first lead line 61 and the second lead line 62 on the touch electrode (the common electrode).

In an exemplary implementation mode, the orthographic projection of the connection part 52 on the base substrate is at least partially overlapped with the orthographic projection of the gate line 20 on the base substrate, the orthographic projection of the connection part 52 on the base substrate is at least partially overlapped with the orthographic projection of the first lead 61 on the base substrate, and the orthographic projection of the connection part 52 on the base substrate is at least partially overlapped with the orthographic projection of the second lead 62 on the base substrate.

In an exemplary implementation mode, at least one connection part 52 of one touch electrode 50 may be connected to the first connection block 61-1 through the first via K1, and at least one connection part 52 of another touch electrode 50 may be connected to the second connection block 62-1 through the second via K2, so that connection points of the first lead 61 and the second lead 62 with the touch electrode are both located in a non-opening region of the sub-pixel, so as to improve the aperture ratio of the sub-pixel.

In an exemplary implementation mode, at least one opening 53 may be provided on the electrode part 51 in the pixel unit, and the fourth conductive thin film in the opening 53 is etched away to expose the third insulating layer. The opening 53 may be in a shape of a bending line extending along the second direction Y, so that the electrode part 51 forms a plurality of strip-shaped electrodes spaced apart along the first direction X, which may ensure that a horizontal electric field is formed between a planar pixel electrode 40 and a strip-shaped common electrode (a touch electrode).

In an exemplary implementation mode, the base substrate may be made of glass or quartz. The first conductive layer and the second conductive layer may be made of metal materials, such as any one or more of silver (Ag), copper (Cu), aluminum (A1) and molybdenum (Mo), or alloy materials of the above metals, such as an aluminum neodymium alloy (AlNd) or a molybdenum niobium alloy (MoNb), and may be a single-layer structure or a multi-layer composite structure, such as Mo/Cu/Mo, etc. The first conductive layer may be referred to as a gate metal (GATE) layer, the second conductive layer may be referred to as a source-drain metal (SD) layer. The third conductive layer and the fourth conductive layer can be made of transparent conductive materials, such as indium tin oxide ITO or indium zinc oxide IZO, etc. The first insulation layer, the second insulation layer, and the third insulation layer may be made of any one or more of Silicon Oxide (SiOx), Silicon Nitride (SiNx), and Silicon Oxynitride (SiON), and may be a single-layer, a multi-layer, or a composite layer. The first insulation layer may be referred to as a Gate Insulation (GI) layer, the second insulating layer may be referred to as an interlayer insulating layer (ILD), and the third insulating layer may be referred to as an Passivation (PVX) layer. An active layer may be made of a material such as amorphous Indium Gallium Zinc Oxide (a-IGZO), Zinc Oxynitride (ZnON), Indium Zinc Tin Oxide (IZTO), amorphous Silicon (a-Si), poly-crystalline Silicon (p-Si), hexathiophene, or polythiophene. That is, the present disclosure is applicable to a transistor that is manufactured based on an oxide technology, a silicon technology, or an organic matter technology.

So far, manufacture of an array substrate according to an exemplary embodiment of the present disclosure is completed. On a plane perpendicular to the array substrate, the array substrate may include a first conductive layer disposed on the base substrate, a first insulating layer disposed on a side of the first conductive layer away from the base substrate, a semiconductor layer disposed on a side of the first insulating layer away from the base substrate, a second conductive layer disposed on a side of the semiconductor layer away from the base substrate, a second insulating layer disposed on a side of the second conductive layer away from the base substrate, a third conductive layer disposed on a side of the second insulating layer away from the base substrate, a fourth insulating layer disposed on a side of the third conductive layer away from the base substrate, and a fourth conductive layer disposed on a side of the fourth insulating layer away from the base substrate. On a plane parallel to the array substrate, the array substrate may include a plurality of sub-pixels, each sub-pixel may include a thin film transistor, a pixel electrode, and a touch electrode reused as a common electrode. The thin film transistor may include a gate electrode, an active layer, a first electrode and a second electrode, the gate electrode is connected to the gate line, the first electrode is connected to the data line, the second electrode is connected to the pixel electrode, the touch electrode is connected to the first lead or the second lead, and a horizontal electric field is formed between the pixel electrode and the common electrode.

As can be seen from the structure and the preparation process of the array substrate according to an exemplary embodiment of the present disclosure, by providing the touch lead group between adjacent pixel units which may include a first lead and a second lead arranged side by side, the present disclosure not only reduces the quantity of leads, increases the space of sub-pixels, improves the pixel aperture ratio, which is beneficial to the improvement of the resolution of the display apparatus, but also ensures the consistency of the pixel structure and the etching uniformity, which is beneficial to the improvement of the quality of the preparation process, since each lead is connected with a corresponding touch electrode through a via.

FIG. 14 is a schematic diagram of a planar structure of a bonding region and a bezel region according to an exemplary embodiment of the present disclosure. As shown in FIG. 14, the array substrate may include a display region 100, a bonding region 200 located at a side of the display region 100, an upper bezel region 310 located at a side of the display region 100 away from the bonding region 200, and a side bezel region 320 located on two sides of the display region 100.

In an exemplary implementation mode, the display region 100 may include at least a plurality of touch electrodes 50 constituting a touch array and a plurality of pixel units 60 constituting a pixel array, at least one pixel unit 60 may include three sub-pixels, at least one sub-pixel may include a thin film transistor 10, a gate line 20, a data line 30, and a pixel electrode 40, the thin film transistor 10 is connected to the gate line 20, the data line 30 and the pixel electrode 40, respectively, and the touch electrodes 50 may be reused as common electrodes.

In an exemplary implementation mode, the display region 100 may also include a plurality of touch lead groups respectively disposed between adjacent pixel columns, at least one touch lead group may include at least a first lead 61 and a second lead 62 provided side by side, the first lead 61 and the second lead 62 are reused as common electrode lines, the first lead 61 may be connected to touch electrodes 50 in an odd-numbered touch row, and the second lead 62 may be connected to touch electrodes 50 in an even-numbered touch row.

In an exemplary implementation mode, the bonding region 200 may include at least a drive chip 280 and a plurality of pins. The drive chip 280 may be correspondingly connected to a plurality of data lines and a plurality of touch leads (the first lead and the second lead) in the display region respectively through a plurality of connection lines. During normal display, the drive chip 280 is configured to provide data signals and touch signals to the plurality of data lines and the plurality of touch leads respectively.

In an exemplary implementation mode, the plurality of pins of the bonding region 200 may include at least any one or more of the following: a first test pin 210, a second test pin 220, a first data pin 230, a second data pin 240, a third data pin 250, a switch control pin 260, and a gate line control pin 270. During testing, the plurality of pins are configured to be bound and connected to an external test apparatus so that the external test apparatus outputs a corresponding signal to a corresponding signal line.

In an exemplary implementation mode, the first test pin 210, the first data pin 230, the switch control pin 260, and the gate line control pin 270 may be disposed at a side of the bonding region 200 in an opposite direction of the first direction X, and the second test pin 220, the second data pin 240, the third data pin 250, and the gate line control pin 270 may be disposed at a side of the bonding region 200 in the first direction X.

In an exemplary implementation mode, the first test pin 210, the first data pin 230, the switch control pin 260, and the gate line control pin 270 may be sequentially disposed along the first direction X, and the gate line control pin 270, the second data pin 240, the third data pin 250, and the second test pin 220 may be sequentially disposed along the first direction X.

In an exemplary implementation mode, the upper bezel region 310 may include at least a test circuit. The array substrate of the present disclosure provides touch lead groups between adjacent pixel units, and a plurality of leads in the touch lead group are adjacent, which may lead to an abnormal touch function when adjacent leads are shorted due to process procedures or Particles, or the like. In order to screen out such defects prior to the module, the present disclosure provides a test circuit in the upper bezel region 310 configured to detect short circuit defects in the array substrate.

In an exemplary implementation mode, the test circuit may include a plurality of test units 70, the plurality of test units 70 may be sequentially disposed along the first direction X, and correspond one-to-one with positions of a plurality of touch columns in the display region 100.

In an exemplary implementation mode, at least one test unit may include at least a first test line 71, a second test line 72, a first data lead 73, a second data lead 74, a third data lead 75, a switch control line 76, a first switch 91, a second switch 92, a third switch 93, a fourth switch 94, and a fifth switch 95.
in an exemplary implementation mode, the switch control line 76, the first data lead 73, the second data lead 74, the third data lead 75, the second test line 72, and the first test line 71 may be sequentially disposed in a direction away from the display region, and the above signal lines are all in a shape of a line extending along the first direction X.

In an exemplary implementation mode, the third switch 93, the fourth switch 94, the fifth switch 95, the first switch 91 and the second switch 92 may be arranged sequentially along the first direction X.

In an exemplary implementation mode, a first electrode of the first switch 91 is connected to the first test line 71, a second electrode of the first switch 91 is connected to the first lead 61 in the display region 100, and a control electrode of the first switch 91 is connected to the switch control line 76, that is, the first test line 71 is connected to the first lead 61 in the display region 100 through the first switch 91, and the first test line 71 is configured to transmit a first test signal to the first lead 61 under control of the switch control line 76 and the first switch 91.

In an exemplary implementation mode, a first electrode of the second switch 92 is connected to the second test line 72, a second electrode of the second switch 92 is connected to the second lead 62 in the display region 100, and a control electrode of the second switch 92 is connected to the switch control line 76, that is, the second test line 72 is connected to the second lead 62 in the display region 100 through the second switch 92, and the second test line 72 is configured to transmit a second test signal to the second lead 62 under control of the switch control line 76 and the second switch 92.

In an exemplary implementation mode, the voltage value of the first test signal is greater than the voltage value of the second test signal, or the voltage value of the first test signal is less than the voltage value of the second test signal, i.e., the voltage value of the first test signal is not equal to the voltage value of the second test signal.

In an exemplary implementation mode, a first electrode of the third switch 93 is connected to the first data lead 73, a second electrode of the third switch 93 is connected to the data line 30 of the first sub-pixel in the display region 100, and a control electrode of the third switch 93 is connected to the switch control line 76, that is, the first data lead 73 is connected to the data line 30 of the first sub-pixel in the display region 100 through the third switch 93, and the first data lead 73 is configured to transmit a first data signal to the data line 30 of the first sub-pixel under control of the switch control line 76 and the third switch 93.

In an exemplary implementation mode, a first electrode of the fourth switch 94 is connected to the second data lead 74, a second electrode of the fourth switch 94 is connected to the data line 30 of the second sub-pixel in the display region 100, and a control electrode of the fourth switch 94 is connected to the switch control line 76, i.e., the second data lead 74 is connected to the data line 30 of the second sub-pixel in the display region 100 through the fourth switch 94, and the second data lead 74 is configured to transmit a second data signal to the data line 30 of the second sub-pixel under control of the switch control line 76 and the fourth switch 94.

In an exemplary implementation mode, a first electrode of the fifth switch 95 is connected to the third data lead 75, a second electrode of the fifth switch 95 is connected to the data line 30 of the third sub-pixel in the display region 100, and a control electrode of the fifth switch 95 is connected to the switch control line 76, that is, the third data lead 75 is connected to the data line 30 of the third sub-pixel in the display region 100 through the fifth switch 95, and the third data lead 75 is configured to transmit a third data signal to the data line 30 of the third sub-pixel under control of the switch control line 76 and the fifth switch 95.

In an exemplary implementation mode, the first switch 91, the second switch 92, the third switch 93, the fourth switch 94 and the fifth switch 95 may be thin film transistors.

In an exemplary implementation mode, the side bezel region 320 may include at least a gate drive circuit 330 and a plurality of connection lines and the gate drive circuit 330 may be disposed at a side of the plurality of connection lines close to the display region.

In an exemplary implementation mode, the side bezel region 320 may include a left side bezel and a right side bezel. The left side bezel may include at least a gate drive circuit 330, a first connection line 81, a third connection line 83, and a sixth connection line 86, and the right side bezel may include at least a gate drive circuit 330, a second connection line 82, a fourth connection line 84, and a fifth connection line 85.

In an exemplary implementation mode, test terminals of the gate drive circuits 330 provided in the left and right side bezels are respectively connected to the gate line control pins 270 in the bonding region 200 through connection lines, and output terminals of the gate drive circuits 330 are respectively connected to a plurality of gate lines 20 in the display region 100. When a test is performed, the test terminal of the gate drive circuit 330 is communicated with the output terminal and the gate drive circuit 330 is configured to output turn-on voltages to a plurality of gate lines 20 in the display region 100.

In an exemplary implementation mode, a first end of the first connection line 81 is connected to the first test pin 210 in the bonding region 200, and a second end of the first connection line 81, after extending toward the upper bezel region 310, is connected to the first test line 71 in the upper bezel region 310, thereby realizing the connection between the first test line 71 and the first test pin 210.

In an exemplary implementation mode, a first end of the second connection line 82 is connected to the second test pin 220 in the bonding region 200, and a second end of the second connection line 82, after extending toward the upper bezel region 310, is connected to the second test line 72 in the upper bezel region 310, thereby realizing the connection between the second test line 72 and the second test pin 220.

In an exemplary implementation mode, a first end of the third connection line 83 is connected to the first data pin 230 in the bonding region 200, and a second end of the third connection line 83, after extending toward the upper bezel region 310, is connected to the first data pin 73 in the upper bezel region 310, thereby realizing the connection between the first data pin 73 and the first data pin 230.

In an exemplary implementation mode, a first end of the fourth connection line 84 is connected to the second data pin 240 in the bonding region 200, and a second end of the fourth connection line 84, after extending toward the upper bezel region 310, is connected to the second data lead 74 in the upper bezel region 310, thereby realizing the connection between the second data lead 74 and the second data pin 240.

In an exemplary implementation mode, a first end of the fifth connection line 85 is connected to the third data pin 250 in the bonding region 200, and a second end of the fifth connection line 85, after extending toward the upper bezel region 310, is connected to the third data lead 75 in the upper bezel region 310, thereby realizing the connection between the third data lead 75 and the third data pin 250.

In an exemplary implementation mode, a first end of the sixth connection line 86 is connected to the switch control pin 260 in the bonding region 200, and a second end of the sixth connection line 86, after extending toward the upper bezel region 310, is connected to the switch control line 76 in the upper bezel region 310, thereby realizing the connection between the switch control line 76 and the switch control pin 260.

In an exemplary implementation mode, the preparation of the test circuit of the present disclosure may include the following operations.

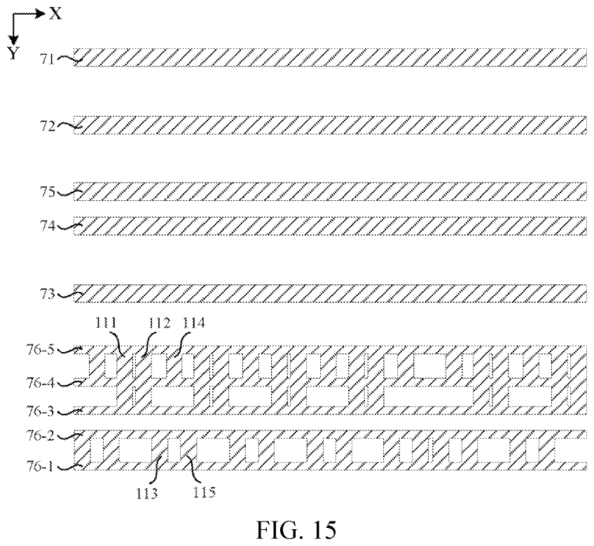

(11) When the pattern of the first conductive layer is formed in the display region, the pattern of the first conductive layer further includes a first test line 71, a second test line 72, a first data lead 73, a second data lead 74, a third data lead 75 and a control line group located in the upper bezel region, as shown in FIG. 15.

In an exemplary implementation mode, the control line group, the first data lead 73, the second data lead 74, the third data lead 75, the second test line 72, and the first test line 71 may be sequentially disposed in a direction away from the display region.

In an exemplary implementation mode, the control line group may include at least a first control line 76-1, a second control line 76-2, a third control line 76-3, a fourth control line 76-4, and a fifth control line 76-5 that are sequentially disposed in a direction away from the display region.

In an exemplary implementation mode, a plurality of first gate blocks 111 and a plurality of second gate blocks 112 may be disposed between the third control line 76-3 and the fifth control line 76-5, first ends of the plurality of first gate blocks 111 and the plurality of second gate blocks 112 are connected to the third control line 76-3, second ends of the plurality of first gate blocks 111 and the plurality of second gate blocks 112 are connected to the fifth control line 76-5, middle parts of the plurality of first gate blocks 111 and the plurality of second gate blocks 112 are connected to the fourth control line 76-4 so that the third control line 76-3, the fourth control line 76-4 and the fifth control line 76-5 are connected into an integral structure by the plurality of first gate blocks 111 and the plurality of second gate blocks 112, the plurality of first gate blocks 111 are configured to serve as a gate electrode of the first switch 91, and the plurality of second gate blocks 112 are configured to serve as a gate electrode of the second switch 92.

In an exemplary implementation mode, a plurality of fourth gate blocks 114 may be disposed between the fourth control line 76-4 and the fifth control line 76-5, first ends of the plurality of fourth gate blocks 114 are connected to the fourth control line 76-4, second ends of the plurality of fourth gate blocks 114 are connected to the fifth control line 76-5, the plurality of fourth gate blocks 114 are configured to serve as a gate electrode of the fourth switch 94.

In an exemplary implementation mode, a plurality of third gate blocks 113 and a plurality of fifth gate blocks 115 may be disposed between the first control line 76-1 and the second control line 76-2, first ends of the plurality of third gate blocks 113 and the plurality of fifth gate blocks 115 are connected to the first control line 76-1, and second ends of the plurality of third gate blocks 113 and the plurality of fifth gate blocks 115 are connected to the second control line 76-2, so that the first control line 76-1 and the second control line 76-2 are connected into an integral structure through the plurality of third gate blocks 113 and the plurality of fifth gate blocks 115, the plurality of third gate blocks 113 are configured to serve as a gate electrode of the third switch 93, and the plurality of fifth gate blocks 115 are configured to serve as a gate electrode of the fifth switch 95.

By adopting a plurality of control lines and a plurality of gate blocks to form a control line group, the present disclosure can effectively reduce the occupied area of the switch, reduce the width of the bezel, and is beneficial to realizing a narrow bezel.

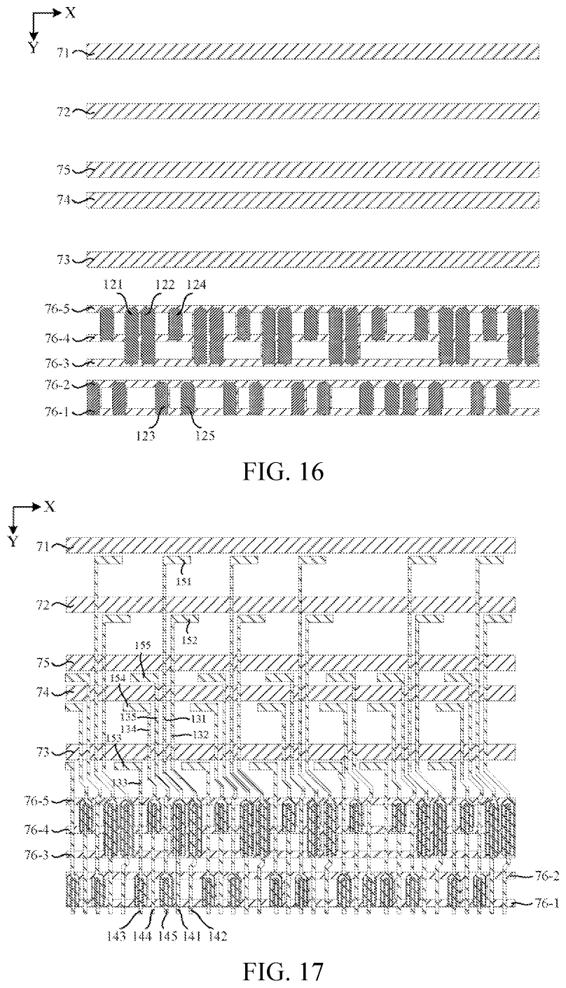

(12) When the pattern of the semiconductor layer is formed in the display region, the pattern of the semiconductor layer further includes a first active layer 121, a second active layer 122, a third active layer 123, a fourth active layer 124, and a fifth active layer 125 located in the upper bezel region, as shown in FIG. 16.

In an exemplary implementation mode, an orthographic projection of the first active layer 121 on the base substrate may be within a range of an orthographic projection of the first gate block 111 on the base substrate, and the first active layer 121 is configured as an active layer of the first switch 91.

In an exemplary implementation mode, an orthographic projection of the second active layer 122 on the base substrate may be within a range of an orthographic projection of the second gate block 112 on the base substrate, and the second active layer 122 is configured as an active layer of the second switch 92.

In an exemplary implementation mode, an orthographic projection of the third active layer 123 on the base substrate may be within a range of an orthographic projection of the third gate block 113 on the base substrate, and the third active layer 123 is configured as an active layer of the third switch 93.

In an exemplary implementation mode, an orthographic projection of the fourth active layer 124 on the base substrate may be within a range of an orthographic projection of the fourth gate block 114 on the base substrate, and the fourth active layer 124 is configured as an active layer of the fourth switch 94.

In an exemplary implementation mode, an orthographic projection of the fifth active layer 125 on the base substrate may be within a range of an orthographic projection of the fifth gate block 115 on the base substrate, and the fifth active layer 125 is configured as an active layer of the fifth switch 95.

(13) When the pattern of the second conductive layer is formed in the display region, the pattern of the second conductive layer further includes a first source electrode 131, a second source electrode 132, a third source electrode 133, a fourth source electrode 134, a fifth source electrode 135, a first drain electrode 141, a second drain electrode 142, a third drain electrode 143, a fourth drain electrode 144, a fifth drain electrode 145, a first lap block 151, a second lap block 152, a third lap block 153, a fourth lap block 154 and a fifth lap block 155 located in the upper bezel region, as shown in FIG. 17.

In an exemplary implementation mode, a first end of the first source electrode 131 is connected to the first active layer 121, and a second end of the first source electrode 131, after extending in a direction away from the display region, is connected to the first lap block 151, the first lap block 151 may be disposed at a side of the first test line 71 close to the display region, and the first lap block 151 is configured to be connected to a subsequently formed first lap electrode. A first end of the first drain electrode 141 is connected to the first active layer 121, and a second end of the first drain electrode 141, after extending in a direction toward the display region, is connected to the first lead of the display region. A conductive channel is formed between the first source electrode 131 and the first drain electrode 141, and the first gate block 111, the first active layer 121, the first source electrode 131 and the first drain electrode 141 constitute the first switch 91.

In an exemplary implementation mode, a first end of the second source electrode 132 is connected to the second active layer 122, and a second end of the second source electrode 132, after extending in a direction away from the display region, is connected to the second lap block 152, the second lap block 152 may be disposed at a side of the second test line 72 close to the display region, and is configured to be connected to a subsequently formed second lap electrode. A first end of the second drain electrode 142 is connected to the second active layer 122, and a second end of the second drain electrode 142, after extending in a direction toward the display region, is connected to the second lead of the display region. A conductive channel is formed between the second source electrode 132 and the second drain electrode 142, and the second gate block 112, the second active layer 122, the second source electrode 132 and the second drain electrode 142 constitute the second switch 92.

In an exemplary implementation mode, a first end of the third source electrode 133 is connected to the third active layer 123, and a second end of the third source electrode 133, after extending in a direction away from the display region, is connected to the third lap block 153, the third lap block 153 may be disposed at a side of the first data lead 73 close to the display region, and is configured to be connected to a subsequently formed third lap electrode. A first end of the third drain electrode 143 is connected to the third active layer 123, and a second end of the third drain electrode 14, after extending in a direction toward the display region, is connected to the data line of the first sub-pixel in the display region. A conductive channel is formed between the third source electrode 133 and the third drain electrode 143, and the third gate block 113, the third active layer 123, the third source electrode 133 and the third drain electrode 143 constitute the third switch 93.

In an exemplary implementation mode, a first end of the fourth source electrode 134 is connected to the fourth active layer 124, and a second end of the fourth source electrode 134, after extending in a direction away from the display region, is connected to the fourth lap block 154, the fourth lap block 154 may be disposed at a side of the second data lead 74 close to the display region, and is configured to be connected to a subsequently formed fourth lap electrode. A first end of the fourth drain electrode 144 is connected to the fourth active layer 124, and a second end of the fourth drain electrode 144, after extending in a direction toward the display region, is connected to the data line of the second sub-pixel in the display region. A conductive channel is formed between the fourth source electrode 134 and the fourth drain electrode 144, and the fourth gate block 114, the fourth active layer 124, the fourth source electrode 134 and the fourth drain electrode 144 constitute the fourth switch 94.

In an exemplary implementation mode, a first end of the fifth source electrode 135 is connected to the fifth active layer 125, and a second end of the fifth source electrode 135, after extending in a direction away from the display region, is connected to the fifth lap block 155, the fifth lap block 155 may be disposed at a side of the third data lead 75 close to the display region, and is configured to be connected to a subsequently formed fifth lap electrode. A first end of the fifth drain electrode 145 is connected to the fifth active layer 125, and a second end of the fifth drain electrode 145, after extending in a direction toward the display region, is connected to the data line of the third sub-pixel in the display region. A conductive channel is formed between the fifth source electrode 135 and the fifth drain electrode 145, and the fifth gate block 115, the fifth active layer 125, the fifth source electrode 135 and the fifth drain electrode 145 constitute the fifth switch 95.

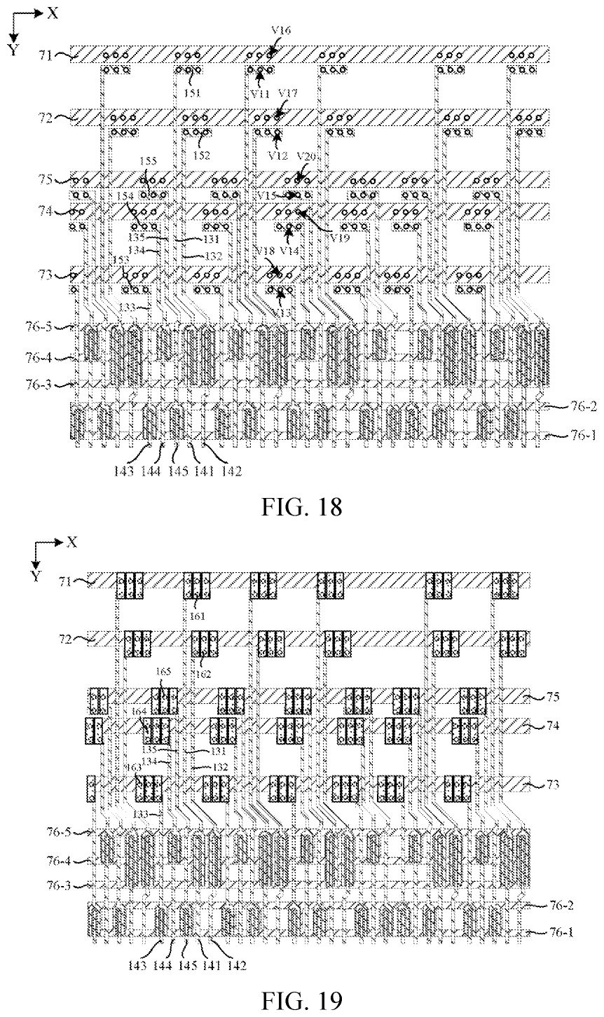

(14) When the pattern of the second insulating layer is formed in the display region, the plurality of vias on the second insulating layer further include an eleventh via V11, a twelfth via V12, a thirteenth via V13, a fourteenth via V14, a fifteenth via V15, a sixteenth via V16, a seventeenth via V17, an eighteenth via V18, a nineteenth via V19, and a twentieth via V20 located in the upper bezel region, as shown in FIG. 18.

In an exemplary implementation mode, an orthographic projection of the eleventh via V11 on the base substrate may be within a range of an orthographic projection of the first lap block 151 on the base substrate, the eleventh via V11 exposes a surface of the first lap block 151, and the eleventh via V11 is configured such that a subsequently formed first lap electrode is connected with the first lap block 151 through the via.

In an exemplary implementation mode, an orthographic projection of the twelfth via V12 on the base substrate may be within a range of an orthographic projection of the second lap block 152 on the base substrate, the twelfth via V12 exposes a surface of the second lap block 152, and the twelfth via V12 is configured such that a subsequently formed second lap electrode is connected with the second lap block 152 through the via.

In an exemplary implementation mode, an orthographic projection of the thirteenth via V13 on the base substrate may be within a range of an orthographic projection of the third lap block 153 on the base substrate, the thirteenth via V13 exposes a surface of the third lap block 153, and the thirteenth via V13 is configured such that a subsequently formed third lap electrode is connected with the third lap block 153 through the via.

In an exemplary implementation mode, an orthographic projection of the fourteenth via V14 on the base substrate may be within a range of an orthographic projection of the fourth lap block 154 on the base substrate, the fourteenth via V14 exposes a surface of the fourth lap block 154, and the fourteenth via V14 is configured such that a subsequently formed fourth lap electrode is connected with the fourth lap block 154 through the via.

In an exemplary implementation mode, an orthographic projection of the fifteenth via V15 on the base substrate may be within a range of an orthographic projection of the fifth lap block 155 on the base substrate, the fifteenth via V15 exposes a surface of the fifth lap block 155, and the fifteenth via V15 is configured such that a subsequently formed fifth lap electrode is connected with the fifth lap block 155 through the via.

In an exemplary implementation mode, an orthographic projection of the sixteenth via V16 on the base substrate may be within a range of an orthographic projection of the first test line 71 on the base substrate, the sixteenth via V16 exposes a surface of the first test line 71, and the sixteenth via V16 is configured such that a subsequently formed first lap electrode is connected with the first test line 71 through the via.

In an exemplary implementation mode, an orthographic projection of the seventeenth via V17 on the base substrate may be within a range of an orthographic projection of the second test line 72 on the base substrate, the seventeenth via V17 exposes a surface of the second test line 72, and the seventeenth via V17 is configured such that a subsequently formed second lap electrode is connected with the second test line 72 through the via.

In an exemplary implementation mode, an orthographic projection of the eighteenth via V18 on the base substrate may be within a range of an orthographic projection of the first data lead 73 on the base substrate, the eighteenth via V18 exposes a surface of the first data lead 73, and the eighteenth via V18 is configured such that a subsequently formed third lap electrode is connected with the first data lead 73 through the via.

In an exemplary implementation mode, an orthographic projection of the nineteenth via V19 on the base substrate may be within a range of an orthographic projection of the second data lead 74 on the base substrate, the nineteenth via V19 exposes a surface of the second data lead 74, and the nineteenth via V19 is configured such that a subsequently formed fourth lap electrode is connected with the second data lead 74 through the via.

In an exemplary implementation mode, an orthographic projection of the twentieth via V20 on the base substrate may be within a range of an orthographic projection of the third data lead 75 on the base substrate, the twentieth via V20 exposes a surface of the third data lead 75, and the twentieth via V20 is configured such that a subsequently formed fifth lap electrode is connected with the third data lead 75 through the via.

The eleventh through twentieth vias V11 to V20 may be a plurality of vias arranged sequentially along the first direction X to improve connection reliability.

(15) When the pattern of the third conductive layer is formed in the display region, the pattern of the third conductive layer further includes a first lap electrode 161, a second lap electrode 162, a third lap electrode 163, a fourth lap electrode 164, and a fifth lap electrode 165 located in the upper bezel region, as shown in FIG. 19.

In an exemplary implementation mode, a first end of the first lap electrode 161 is connected to the first lap block 151 through the eleventh via V11, and a second end of the first lap electrode 161 is connected to the first test line 71 through the sixteenth via V16.

In an exemplary implementation mode, a first end of the second lap electrode 162 is connected to the second lap block 152 through the twelfth via V12, and a second end of the second lap electrode 162 is connected to the second test line 72 through the seventeenth via V17.

In an exemplary implementation mode, a first end of the third lap electrode 163 is connected to the third lap block 153 through the thirteenth via V13, and a second end of the third lap electrode 163 is connected to the first data lead 73 through the eighteenth via V18.

In an exemplary implementation mode, a first end of the fourth lap electrode 164 is connected to the fourth lap block 154 through the fourteenth via V14, and a second end of the fourth lap electrode 164 is connected to the second data lead 74 through the nineteenth via V19.

In an exemplary implementation mode, a first end of the fifth lap electrode 165 is connected to the fifth lap block 155 through the fifteenth via V15, and a second end of the fifth lap electrode 165 is connected to the third data lead 75 through the twentieth via V20.

The first lap electrode 161 to the fifth lap electrode 165 may be a plurality of lap electrodes arranged sequentially along the first direction X to improve connection reliability.

So far, preparation of a test circuit according to an exemplary embodiment of the present disclosure has been completed, the test circuit may include a plurality of test units, the plurality of test units may be arranged sequentially along the first direction X, and at least one test unit may include at least a first test line 71, a second test line 72, a first data lead 73, a second data lead 74, a third data lead 75, a switch control line 76, a first switch 91, a second switch 92, a third switch 93, a fourth switch 94, and a fifth switch 95.

In an exemplary implementation mode, the process of detecting a plurality of touch electrodes in the display region by the test circuit may include following operations.

(1) After the external test apparatus is bound and connected to a plurality of pins in the bonding region, the external test apparatus provides an activation signal to the gate control pin 270, a turn-on signal to the switch control pin 260, and a data signal to the first data pin 230, the second data pin 240, and the third data pin 250, respectively. In an exemplary implementation mode, the turn-on signal and the activation signal may be a high-level voltage (VGH) and the data signal may be a common reference voltage (VCOM). The activation signal supplied by the external test apparatus causes the gate drive circuit 330 to output an activation voltage to the plurality of gate lines 20 in the display region, and the thin film transistors of the plurality of sub-pixels in the display region are turned on. The turn-on signal provided by the external test apparatus causes the first switches 91, the second switches 92, the third switches 93, the fourth switches 94 and the fifth switches 95 of the plurality of test units 70 in the upper bezel region to be turned on, and the data signal provided by the external test apparatus is respectively provided to the plurality of data lines 30 of the display region through the first data lead 73 and the turned-on third switch 93, the second data lead 74 and the turned-on fourth switch 94, the third data lead 75 and the turned-on fifth switch 95, respectively, and transmitted to the pixel electrodes 40 of the plurality of sub-pixels through the turned-on thin film transistors, so that the pixel electrodes 40 of the plurality of sub-pixels in the display region are charged with the common reference voltage. In this stage, the pixel electrodes are turned on in advance by a signal, and charged with the common reference voltage before the arrival of a first test signal and a second test signal.

(2) The external test apparatus provides the first test signal to the first test pin 210 and the second test signal to the second test pin 220. In an exemplary implementation mode, the first test signal may be a first gray-scale voltage, the second test signal may be a second gray-scale voltage, the voltage value of the first gray-scale voltage may be greater than the voltage value of the second gray-scale voltage, or the voltage value of the first gray-scale voltage may be less than the voltage value of the second gray-scale voltage. The first test signal supplied by the external test apparatus is provided to the first lead 61 of the display region through the first test line 71 and the turned-on first switch 91, and is transmitted to a plurality of touch electrodes 50 connected to the first lead 61 so that a plurality of sub-pixels corresponding to the touch electrodes 50 display a first gray scale. The second test signal supplied by the external test apparatus is provided to the second lead 62 of the display region through the second test line 72 and the turned-on second switch 92, and is transmitted to a plurality of touch electrodes 50 connected to the second lead 62, so that a plurality of sub-pixels corresponding to the touch electrodes 50 display a second gray scale.

In an exemplary implementation mode, since pixel electrodes 40 of all sub-pixels in the display region have a common reference voltage and touch electrodes 50 reused as common electrodes have the first gray-scale voltage and the second gray-scale voltage, respectively, all sub-pixels in the display region display a first gray scale and a second gray scale, respectively.

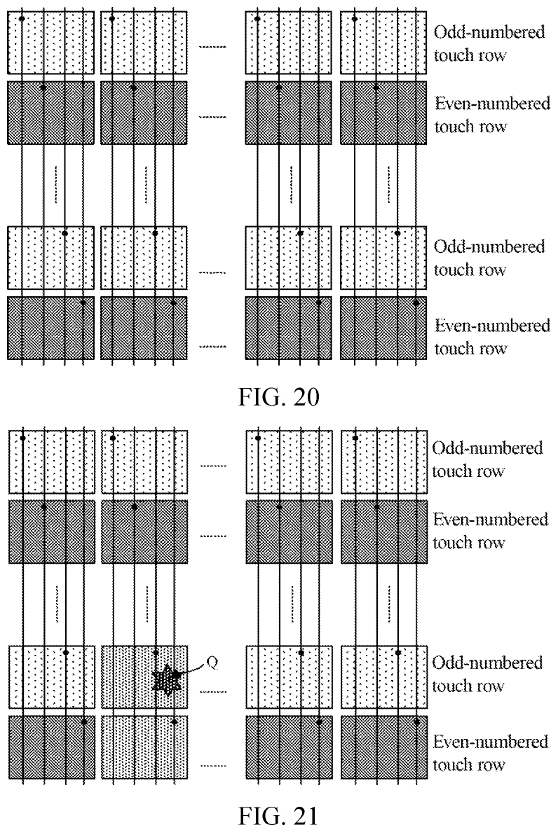

FIGS. 20 and 21 are schematic diagrams of a short circuit detection by the detection circuit according to the present disclosure. FIG. 20 is a normal detection picture when there is no short circuit defect, and FIG. 21 is an abnormality detection picture when there is a short circuit defect. In an exemplary implementation mode, the first lead is connected to the touch electrodes 50 in an odd-numbered touch row and the second lead is connected to the touch electrodes 50 in an even-numbered touch row.

In an exemplary implementation mode, when there is no short circuit defect on the array substrate, the touch electrodes 50 in an odd-numbered touch row display the first gray scale, and the touch electrodes 50 in an even-numbered touch row display the second gray scale, and the display region realizes a uniform display picture that is alternately brightened and darkened in a longitudinal direction, as shown in FIG. 20.

In an exemplary implementation mode, when there is a short circuit defect on the array substrate, such as a short circuit point Q in a first lead and a second lead which are adjacent, since the first lead and the second lead which are short circuited have a same voltage at this time, a voltage of one touch electrode 50 in an odd-numbered row is the same as that of one touch electrode 50 in an adjacent even-numbered row, so that a region where adjacent two touch electrodes 50 are located display a same gray scale, which is different from the normal display picture, so that a defective substrate can be screened out, as shown in FIG. 21.

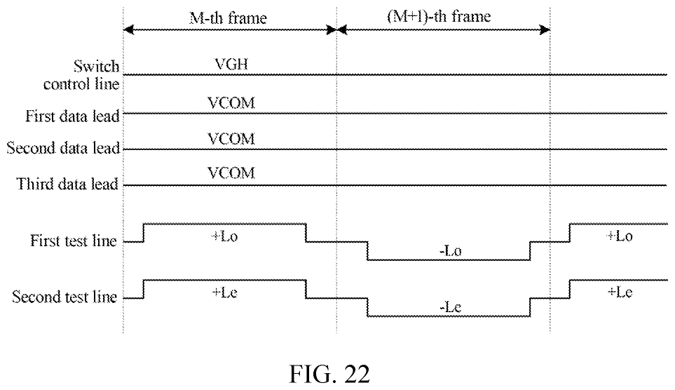

FIG. 22 is a schematic diagram of detection timing when short circuit detection is performed by the detection circuit according to the present disclosure. As shown in FIG. 22, in an exemplary implementation mode, in order to prevent an afterimage caused by deflection polarization of the liquid crystal in the same direction, the first gray-scale voltage and the second gray-scale voltage provided to the first test line and the second test line are reversed in positive polarity and negative polarity from frame to frame. For example, in an M-th frame, the first gray-scale voltage +Lo is provided to the first test line and the second gray-scale voltage +Le is provided to the second test line. In an (M+1)-th frame, the first gray-scale voltage-Lo is provided to the first test line and the second gray-scale voltage-Le is provided to the second test line.

As can be seen from the structure, the preparation process and the test process of the test circuit of the exemplary embodiment of the present disclosure, the present disclosure provides two touch leads between adjacent pixel units, with one touch lead being connected with a touch electrodes in an odd-numbered touch row, and another touch lead being connected with a touch electrodes in an even-numbered touch row, by providing different gray-scale voltages to the two touch leads respectively, when there is no short circuit defect on the array substrate, a plurality of touch rows present a display picture that is alternately brightened and darkened in a longitudinal direction, and when there is a short circuit defect on the array substrate, the longitudinal adjacent touch electrodes will display the same gray scale, so that the short-circuit defect on the array substrate can be screened out. The structure of the test circuit of the present disclosure is simple and the testing method is concise, which can effectively screen out defective substrates, reduce the loss of module materials, lower the production cost and improve the yield.

The exemplary embodiments of the present disclosure further provide a display apparatus, the display apparatus may include a first substrate and a second substrate oppositely arranged, a liquid crystal layer is disposed between the first substrate and the second substrate, and the first substrate may adopt the aforementioned array substrate, and the second substrate may include a black matrix and a filter unit.

In an exemplary implementation, the display apparatus in the present disclosure may be any product or component with a display function, such as a mobile phone, a tablet computer, a television, a display, a notebook computer, a digital photo frame, or a navigator, and the embodiments of the present invention are not limited thereto.

Exemplary embodiments of the present disclosure also provide a testing method for an array substrate using the array substrate as described above, including:
Providing turn-on voltages to a plurality of gate lines in a display region, such that thin film transistors of a plurality of sub-pixels in the display region are turned on; providing a common reference voltage to a plurality of data lines in the display region, such that pixel electrodes of the plurality of sub-pixels in the display region have the common reference voltage;
Providing a first gray-scale voltage to a first lead in the display region such that a plurality of touch electrodes connected to the first lead in the display region have a first gray-scale voltage; providing a second gray-scale voltage to a second lead in the display region such that a plurality of touch electrodes connected to the second lead in the display region have a second gray-scale voltage; wherein a voltage value of the first gray-scale voltage is greater than a voltage value of the second gray-scale voltage, or the voltage value of the first gray-scale voltage is less than the voltage value of the second gray-scale voltage.

In an exemplary implementation mode, when there is no short circuit defect on the array substrate, touch electrodes in one touch row display a first gray scale, touch electrodes in an adjacent touch row display a second gray scale, and the display region presents a display picture that is alternately brightened and darkened in a longitudinal direction; when there is a short circuit defect on the array substrate, at least one touch electrode in one touch row displays a same gray scale as at least one touch electrode in an adjacent touch row.

Although implementation modes disclosed in the present disclosure are described as above, the described contents are only implementation modes which are used for facilitating understanding of the present disclosure, but are not intended to limit the present invention. Any skilled person in the art to which the present disclosure pertains may make any modification and variation in a form and details of implementation without departing from the spirit and scope of the present disclosure. However, the patent protection scope of the present invention should be subject to the scope defined in the appended claims.

1. An array substrate comprising a display region, wherein the display region comprises at least: a plurality of touch electrodes constituting a plurality of touch rows and a plurality of touch columns, and a plurality of pixel units constituting a plurality of pixel rows and a plurality of pixel columns, orthographic projections of the touch units on the array substrate are at least partially overlapped with orthographic projections of the plurality of pixel units on the array substrate, a pixel unit comprises a plurality of sub-pixels; a touch lead group is provided between at least one adjacent pixel columns; the touch lead group comprises at least a first lead and a second lead provided side by side; the first lead is connected with a touch electrode in a touch row, and the second lead is connected with another touch electrode in an adjacent touch row.

2. The array substrate according to claim 1, wherein at least one touch column comprises N touch electrodes arranged sequentially along a pixel column direction, an orthographic projection of the touch column on the array substrate is at least partially overlapped with orthographic projections of N/2 pixel columns on the array substrate, the first lead located between an i-th pixel column and an (i+1)-th pixel column is connected to touch electrodes in an (2i-1)-th touch row, the second lead located between the i-th pixel column and the (i+1)-th pixel column is connected to touch electrodes in an 2i-th touch row, N is an even number greater than 1, and i is a positive integer greater than or equal to 1 and less than or equal to N/2.

3. The array substrate according to claim 1, wherein at least one pixel unit comprises a first sub-pixel, a second sub-pixel and a third sub-pixel arranged sequentially along a pixel row direction, the sub-pixel comprises a gate line, a data line, a thin film transistor and a pixel electrode, the thin film transistor is respectively connected to the gate line, the data line and the pixel electrode, the touch electrode is reused as a common electrode, and the first lead and the second lead are reused as common electrode lines; the first lead is disposed at a side of the third sub-pixel away from the first sub-pixel, and the second lead is disposed at a side of the first lead away from the first sub-pixel.

4. The array substrate according to claim 3, wherein, in at least one pixel row, a first connection block is provided on the first lead, and the first connection block is connected with one touch electrode through a first via.

5. The array substrate according to claim 4, wherein, in at least one pixel row, the first lead comprises at least a first straight line segment, a second straight line segment, and a bending segment between the first straight line segment and the second straight line segment, a first end of the bending segment is connected to the first straight line segment, a second end of the bending segment is connected to the second straight line segment, a middle part of the bending segment protrudes in a direction away from the second lead, and the first connection block is disposed in a region formed by bending of the bending segment.

6. The array substrate according to claim 4, wherein an orthographic projection of the first connection block on the array substrate is at least partially overlapped with an orthographic projection of the gate line on the array substrate.

7. The array substrate according to claim 4, wherein an orthographic projection of the first via on the array substrate is at least partially overlapped with an orthographic projection of the gate line on the array substrate.

8. The array substrate according to claim 3, wherein, in at least one pixel row, a second connection block is provided on the second lead, and the second connection block is connected with another touch electrode through a second via.

9. The array substrate according to claim 8, wherein, in at least one pixel row, the first lead comprises at least a first straight line segment, a second straight line segment, and a bending segment between the first straight line segment and the second straight line segment, a first end of the bending segment is connected to the first straight line segment, a second end of the bending segment is connected to the second straight line segment, a middle part of the bending segment protrudes in a direction away from the second lead, and the second connection block is disposed in a region formed by bending of the bending segment.

10. The array substrate according to claim 8, wherein an orthographic projection of the second connection block on the array substrate is at least partially overlapped with an orthographic projection of the gate line on the array substrate.

11. The array substrate according to claim 8, wherein an orthographic projection of the second via on the array substrate is at least partially overlapped with an orthographic projection of the gate line on the array substrate.

12. The array substrate according to claim 3, wherein, in at least one pixel unit, the touch electrode comprises an electrode part and a connection part, the electrode part is disposed within the pixel unit, the connection part is disposed between adjacent pixel units and connected with electrode parts within the adjacent pixel units.

13. The array substrate according to claim 12, wherein, in at least one pixel unit, an orthographic projection of the electrode part on the array substrate is not overlapped with an orthographic projection of the gate line on the array substrate, an orthographic projection of the electrode part on the array substrate is not overlapped with an orthographic projection of the first lead line on the array substrate, and an orthographic projection of the electrode part on the array substrate is not overlapped with an orthographic projection of the second lead line on the array substrate.

14. The array substrate according to claim 12, wherein, in at least one pixel unit, an orthographic projection of the connection part on the array substrate is at least partially overlapped with an orthographic projection of the gate line on the array substrate, an orthographic projection of the connection part on the array substrate is at least partially overlapped with an orthographic projection of the first lead line on the array substrate, and an orthographic projection of the connection part on the array substrate is at least partially overlapped with an orthographic projection of the second lead line on the array substrate.

15. The array substrate according to claim 12, wherein, in at least one pixel unit, at least one connection part is connected to the first lead through a first via, or at least one connection part is connected to the second lead through a second via.

16. The array substrate according to claim 1, wherein the array substrate further comprises a bonding region located at a side of the display region and an upper bezel region located at a side of the display region away from the bonding region; the bonding region comprises at least a plurality of pins, the upper bezel region comprises at least a test circuit, the test circuit is correspondingly connected with the plurality of pins of the bonding region through a plurality of connection lines, and the test circuit is configured to detect short circuit defects of the array substrate.

17. The array substrate according to claim 16, wherein the test circuit comprises a plurality of test units corresponding to positions of the plurality of touch columns; at least one test unit comprises a first test line, a second test line, a switch control line, a first switch and a second switch; the first test line is connected with the first lead in the display region through the first switch, the second test line is connected with the second lead in the display region through the second switch, and the switch control line is connected with control terminals of the first switch and the second switch; the first test line is configured to transmit a first gray-scale voltage to the first lead under control of the switch control line, and the second test line is configured to transmit a second gray-scale voltage to the second lead under control of the switch control line; a voltage value of the first gray-scale voltage is greater than a voltage value of the second gray-scale voltage, or the voltage value of the first gray-scale voltage is less than the voltage value of the second gray-scale voltage,
wherein the test unit further comprises a first data lead, a second data lead, a third data lead, a third switch, a fourth switch, and a fifth switch, the first data lead is connected with a data line of a first sub-pixel in the display region through the third switch, the second data lead is connected with a data line of a second sub-pixel in the display region through the fourth switch, the third data lead is connected with a data line of a third sub-pixel in the display region through the fifth switch, the switch control line is connected with control terminals of the third switch, the fourth switch and the fifth switch; the first data lead, the second data lead, and the third data lead are configured to transmit a common reference voltage to data lines of the display region under control of the switch control line.

18. (canceled)

19. A display apparatus, comprising the array substrate according to claim 1.

20. A testing method for an array substrate using the array substrate according to claim 1, comprising:
providing turn-on voltages to a plurality of gate lines in a display region, to turn on thin film transistors of a plurality of sub-pixels in the display region; providing a common reference voltage to a plurality of data lines in the display region, to cause pixel electrodes of the plurality of sub-pixels in the display region to have the common reference voltage; and
providing a first gray-scale voltage to a first lead in the display region to cause a plurality of touch electrodes connected to the first lead in the display region to have a first gray-scale voltage; providing a second gray-scale voltage to a second lead in the display region to cause a plurality of touch electrodes connected to the second lead in the display region to have a second gray-scale voltage; wherein a voltage value of the first gray-scale voltage is greater than a voltage value of the second gray-scale voltage, or the voltage value of the first gray-scale voltage is less than the voltage value of the second gray-scale voltage.

21. The testing method according to claim 20, wherein, when there is no short circuit defect on the array substrate, touch electrodes in one touch row display a first gray scale, touch electrodes in an adjacent touch row display a second gray scale, and the display region presents a display picture that is alternately brightened and darkened in a longitudinal direction; when there is a short circuit defect on the array substrate, at least one touch electrode in one touch row displays a same gray scale as at least one touch electrode in an adjacent touch row.
